(19) United States
(12) Patent Application Publication
(10) Pub. No.: US 2017/0361219 A1
(43) Pub. Date: Dec. 21, 2017

(54) Utilization Of In-Game Currency In A Movie Trivia Game.

(71) Applicants: Max Abecassis, Boca Raton, FL (US); Ryan M. Donahue, Boynton Beach, FL (US)

(72) Inventors: Max Abecassis, Boca Raton, FL (US); Ryan M. Donahue, Boynton Beach, FL (US)

(73) Assignee: CustomPlay LLC

(21) Appl. No.: 15/188,348

(22) Filed: Jun. 21, 2016

(51) Int. Cl. A63F 13/214; A63F 9/18; A63F 13/25

(52) U.S. Cl. CPC A63F 13/214; A63F 13/25; A63F 9/183

(57) ABSTRACT

Methods of displaying, for a first player, at least one of a plurality of single-player movie trivia game sessions; awarding, responsive to the first player playing at least one of a plurality of single-player movie trivia game sessions, an amount of in-game currency to the first player; enabling the first player to establish a multiplayer movie trivia game session by risking an amount of in-game currency awarded to the first player; enabling a multiplayer movie trivia game session competition between the first player and a second player risking an equivalent amount of the in-game currency; displaying, for a first player and for the second player, a set of questions from a plurality of movie related questions; and awarding, responsive to the multiplayer movie trivia game session competition, the amount of in-game currency risked by the first player and by the second player.

### BACKGROUND OF THE INVENTION

### 1. Field of the Invention

Systems and methods for using in-game currency in a movie trivia game displaying movie related trivia questions and information.

### 2. Description of the Related Art

Systems for, and methods of, displaying movie related information. The related art includes, for example, U.S. publication 2013/0251337 titled “Providing item information during video playing”; U.S. publication 2013/0343721 titled “Playing A Video Presentation With Playback Functions”; and U.S. publication 2015/0110458 titled “Second Screen Trivia Function.

### BRIEF SUMMARY OF THE INVENTIONS

The present inventions relate to methods of displaying movie related trivia questions and information on an apparatus (e.g., a smartphone, a tablet, a hybrid, a laptops, and a computing communications device) comprising processing, memory, and communications capabilities required to operate an application's various functions and capable of displaying trivia questions and information relating to one or multiple movies in a competitive game and information format that utilizes in-game currency. Preferred embodiments comprise methods of displaying, for displaying, for a player, at least one of a plurality of single-player movie trivia game sessions, wherein the at least one of a plurality of single-player movie trivia game sessions comprises a set of movie related questions derived from a single movie that is responsive to a movie preference of the player, and wherein the at least one of the plurality of single-player movie trivia game sessions implements a point scoring system that is responsive to a multiple-try scheme; awarding, responsive to the player playing at least one of a plurality of single-player movie trivia game sessions, an amount of in-game currency to the player; enabling the player to establish a multiplayer movie trivia game session by risking an amount of in-game currency awarded to the player in the playing of the at least one of the plurality of single-player movie trivia game sessions; enabling a multiplayer movie trivia game session between the player and multiple other players, each risking an equivalent amount of the in-game currency, wherein the multiplayer movie trivia game session implements a point scoring system that is responsive to a multiple-try scheme; displaying, for a player and for the multiple other players, a set of questions from a plurality of movie related questions; and awarding, responsive to the multiplayer movie trivia game session, the amount of in-game currency risked by the player and by the multiple other players.

Accordingly, it is an object of the present inventions to display in a movie trivia game questions and information relating to a specific movie, a series of movies, a genre of movies, a specialty genre of movies, a movie theme, and/or a movie conflict.

It is also an object of the present inventions to provide, on a device, a movie trivia game application comprising a set of questions that are immersed within the context of one or a plurality of movies and that cover a broad range of entertaining and informative categories.

It is also an object of the present inventions to include in a movie trivia game questions and information relating to one or multiple subject categories.

It is also an object of the present inventions to display trivia questions and information that are responsive to a user's preferences for the level of relative difficulty of the individual trivia questions, or the difficulty of the assortment of trivia questions.

It is also an object of the present inventions to provide a movie trivia game comprising a question and multiple answer methodology implementing a multi-try scoring methodology.

It is also an object of the present inventions to provide a movie trivia game that enables competition among one or a plurality of users.

It is also an object of the present inventions to provide a movie trivia game that implements an in-game currency and an in-game store.

It is also an object of the present inventions to provide a movie trivia game that implements a trivia game challenge among one or a plurality of users involving in-game currency.

Briefly, these and other objects are enabled by systems for, and methods of, for example, analyzing a movie to identify trivia question and information opportunities; and creating a movie data set comprising movie-specific questions, answers, related information (e.g., level of difficulty of a question, set of questions, and movie set of questions), and related images. The movie data also comprises descriptors (e.g., identification of the series, genre, specialty genre, theme, conflict, subject of the movie, movie release date, map release date), write-ups, video frame identifications, and website links to support the various movie information objectives. A plurality of movies data sets support the single player and multiplayer modes and enable expanding the application resources as new movie data sets are made available for newly released or previously released movies.

The movie trivia game application and movie data sets are utilized by and/or downloaded to systems such remote web server that processes API requests from a user's device, a website server, a smartphone, a tablet, a hybrid, a laptops, and a computing communications device comprising processing, memory, communications, and a display. Individual data sets may be downloaded responsive to a user selection of a movie in single player mode. Alternatively, the only the data necessary support single player or multiplayer modes is extracted and downloaded from a database comprising a plurality of movie data sets.

The movie trivia game comprises, for example, a system (e.g., a user's device, a smartphone, a tablet, and a computing communications device) for performing the steps of: downloading movie data; displaying a movie related question responsive to a user's preferences; displaying a plurality of answers associated with the movie related question; and displaying, subsequent to receiving a user's answer selection in response to the displayed plurality of answers associated with the movie related question, supplementary information related to the immediately preceding question. Advantageously, in the movie trivia game, the awarding of points is responsive to a number of tries required by the user to select a correct answer from the displayed plurality of answers associated with a movie related question.

In single player mode, the game comprises displaying a plurality of trivia questions, each of which is associated with a plurality of displayed answers; receiving a user's answer selections in response to each of the displayed plurality of trivia questions; and awarding in-game currency responsive to the points awarded during the game. In multiplayer mode, the points awarded to a user's answer selections in response to the displayed plurality of trivia questions is then compared to the answer selections, by one or a plurality of users, in response to the displayed plurality of the same trivia questions. Advantageously, the multiplayer trivia game enhances the enjoyment of a user testing their movie knowledge and skill in answering questions against other similarly interested users by implementing gaming functions comprising the risking of in-game currency. In this context of participating in a multiplayer trivia game comprising risking of in-game currency, the single player mode advantageously serves to facilitate the user acquiring the skills, knowledge, and in-game currency to enjoy challenging other users to a multiplayer trivia game.

These and other embodiments, features, advantages, and objects, are apparent in the context of the detailed description, accompanying drawings, and appended claims that follow. As is detailed below, the present inventions define novel systems and methods that produce useful, new, unexpected, and unpredictable significant results that offer material advantages.

### BRIEF DESCRIPTION OF THE DRAWINGS

The following drawing figures, that form a part of this application, are illustrative of embodiments of the present invention and are not meant to limit the scope of the invention in any manner.

FIG. 1A is an illustration of an application interface enabling the selection of a movie trivia game's single player or multiplayer modes;

FIG. 1B is an illustration of an application interface enabling the selection of a game session in single player mode;

FIG. 2A is an illustration of an application interface enabling the selection of one movie in single player mode;

FIG. 2B is an illustration of an application interface enabling the start of an act in a movie selected in single player mode;

FIG. 3A is an illustration of an application interface displaying information and features of a dilemma question;

FIG. 3B is an illustration of an application interface displaying information and features of the dilemma subject category;

FIG. 4A is an illustration of an application interface displaying information and features of a recipe question;

FIG. 4B is an illustration of an application interface displaying information and features of the recipe subject category;

FIG. 5A is an illustration of an application interface displaying information and features of a performer/character identification question;

FIG. 5B is an illustration of an application interface displaying information and features of the performer/character category;

FIG. 6A is an illustration of an application interface displaying information and features of a location question;

FIG. 6B is an illustration of an application interface displaying information and features of the locations subject category;

FIG. 7A is an illustration of an application interface displaying information and features of a superfan question;

FIG. 7B is an illustration of an application interface displaying information and features of the superfan subject category;

FIG. 8A is an illustration of an application interface displaying information and features of a music question;

FIG. 8B is an illustration of an application interface displaying information and features of the music subject category;

FIG. 9A is an illustration of an application interface displaying information and features of a shopping question;

FIG. 9B is an illustration of an application interface displaying information and features of the shopping subject category;

FIG. 10A is an illustration of an application interface enabling the establishment of a movie trivia session in multiplayer mode;

FIG. 10B is an illustration of an application interface depicting the display of a user's pending movie trivia sessions in multiplayer mode;

FIG. 11A is an illustration of an application interface displaying information and features of a dilemma question in the movie trivia game during a multiplayer session;

FIG. 11B is an illustration of an iPhone implementation of the application interface displaying information and features of a movie trivia game question;

FIG. 12 is a schematic diagram of a communications, systems, apparatus, and devices infrastructure; and

FIG. 13 is a flow chart of a method of playing a movie trivia game.

### DETAILED DESCRIPTION OF THE INVENTIONS

For purposes of the present disclosure, various terms used in the art are defined as follows:

The term “herein” shall mean in the entirety of this specification including drawings, abstract, and claims. The term herein is not limited to the paragraph or section in which it may appear.

The terms “include”, “comprise”, and “contains” do not limit the elements to those listed. By contrast, only the term “consist” limits the elements to those listed.

No conceptual distinction should be drawn from the use of the terms “on”, “at”, or “in” (e.g., no distinction should be drawn from the use of the phrase receiving on, receiving at, or receiving in a device).

No conceptual distinction should be drawn between the use of the terms “and”, “and/or”, or “or”. For example, the scope of the embodiment is not narrowed by the use of the term “and” rather than the use of the terms “and/or”, or “or”. The applicability of the “and/or” concept is not limited to the explicit instances where the terms “and/or” are used. The explicit use of the terms “and/or” serves to underscore the available permutations.

The term “responsive” does not limit the elements, conditions, preferences, and/or requirements that may be taken into consideration. For example, an event that is responsive to a specified requirement is not limited to being responsive to only that specified requirement. An event may be responsive to a specified requirement and may be responsive, although not necessarily, to a second non-specified requirement, specially, when the second requirement, while described as an alternative requirement, may be also deemed complementary.

The terms “application software”, “software application”, “application”, “app”, “routine”, and “computer software” shall mean any one or more executables, libraries, scripts, instructions, and/or processor executable steps in any format that causes, or is required by, a system to perform a task, function, or process. Application software or routines comprises a computer program designed to assist a user to perform task, function, process, or activity. In some instances application software and operating system software may be synergistically integrated and indivisible.

The term “associate” shall mean assign, give, allocate, associate, designate, ascribe, attribute, link, and/or relate.

The term “descriptor” shall mean a keyword, word, term, code, phrase, designations, write-ups, and linkages. The term descriptor shall also mean any information, image, and video-frame that identifies, describes, links, and/or categorizes content of a movie, portions of a movie, or a video-frame. A linkage is any information, data, link, or method that enables retrieving and/or downloading data from a local/internal and/or a remote/external source.

The term “downloading” shall mean downloading, transferring, retrieving, receiving, and otherwise obtaining. A downloading of, for example, data or information need not be completed in its entirety prior another process. A downloading may be executed contemporaneously with another process and/or as related process requires or is particularly desired.

The term “geographic map” shall mean any map, including satellite, topographical, street, and such maps as Google Maps, Google Earth, Google Earth View, Google Street View, OpenStreetMap, and whether 2D or 3D, static or dynamic and interactive, single or multi-featured, and representative or photorealistic. The term “geographic map” shall also mean any depiction (e.g., map) that provides context for a locale.

The term “in-game currency” shall mean any in-game currency, virtual currency, credits, tokens, virtual coins, virtual money, or virtual item of value. In in-game currency includes any virtual value that enables establishing an in-game marketplace. In a preferred embodiment, which may enable the monetary purchase of in-game currency, the in-game currency does not represent, store, and can be converted into monetary value.

The term “information” shall mean information, infotainment, data, descriptors, keywords, linkages, write-ups, and/or features. Information may also mean any content or material that may inform and/or entertain. Information may be provided as text, image, audio, movie, and multimedia content. Information may be factual or fictional.

The term “item” shall mean: (i) an object, article, artifact, instrument, device, and product; (ii) a specific act or action within an activity, process, event, and operation; (iii) an emotion, expression, gesture, and movement; (iv) an effect, consequence, and result; (v) a sound, occasional foreign language, and melodic content; (vi) a portion of a dialog, line, and linguistic expression; (vii) cinematography, cinematographic technique, cinematographic effect, a special effect, technical transition, and production error; (viii) a cameo or special appearance; and (ix) a locale.

The term “keywords” shall mean words, terms, phrases, designations, codes, descriptors, labels, data, metadata, and numbers. The term “keywording” shall mean associating keywords.

The term “locale” shall mean a locale, location, site, setting, place, area, spot, landmark, location of interest, tourist attraction, building, building exterior, building interior, structure, and a geographically identifiable point. A locale is generally a location or place outside of the movie studio that is used for filming a movie or portion of a movie. A locale may be depicted as the actual locale or may be represented in the depictions as a locale other than the actual locale. The term “locale” is differentiated from the term “location” when the term location refers to a point in the timeline of the movie.

The term “movie” shall mean any moving image regardless of the source, motion, or technology implemented. A movie may comprise images and audio found in videos, full motion picture programs, films, movies, interactive electronic games, multi-media content, television programs, commercials, advertisements, and/or entertaining, instructional, and/or educational programming. A typical, but not exclusive, example of a movie is a full length motion picture usually released in theaters and/or optical discs (e.g., a DVD-Movie or Blu-ray Disc). Responsive to the particular embodiment implemented, subtitles, sub picture information, user interface, application software, software program routines, system control codes for controlling the playing of the video/audio, movie map, bookmark instructions, seek/step data, and/or map synchronization data may be provided with a movie.

The terms “movie data”, “data set”, and “data”, shall mean any information and data, whether, for example, arranged in a table, database, listing, and/or index. Movie data may comprise, for example, information to support the various movie trivia game embodiments, the various user preferences including, for example: a user's movie selection preference, a user's preference for one or multiple movie subject categories, and/or user's preference for the level of relative difficulty of the individual trivia questions; and the information, in-game currency, in-game shopping, individual's scores, community scores, game results, and the multiplayer objectives of the movie trivia game. Movie data may comprise, for example, movie trivia questions, answer options, and related information, data, textual, image, audio, and/or movie content; linkages to internal/external sources of information/content, supplementary information, and/or such information, data, linkages, and content that may required to enable or support the methodologies, features and/or functions detailed herein. Movie data need not comprise any particular information, data, information set, or data set.

The term “noteworthy” in connection with content shall mean content that: (i) may be of interest to a significant audience; (ii) is noteworthy, remarkable, or compelling; and/or (iii) is uncommon, atypical, peculiar, unusual, unique, rare, or extraordinary.

The term “performer” shall mean an individual, participant, actor, or actress, appearing in a movie and/or credited for the physical and/or the verbal performance of a character. A performer refers to, for example, an actor in a movie, an athlete in a televised sporting event, a newscaster in a news program, and a chef in a cooking show.

The terms “play” and “playing”, as in play or playing a segment of a movie, shall mean playing meaningfully, or substantially all or a portion of a segment. In other words, while a method or system disclosed herein may claim or intend to play the entirety of, or all, of a segment, a complete playing of a segment does not necessarily require the playing of every video-frame, interlaced field, audio and sub picture portion, and/or bit of data of the segment.

The term “plot info” shall mean information, rationale, and/or explanation relating to, or relevant to understanding or appreciating, a plot, sub-plot, theme, storyline, principle, idea, key point, clue, and/or item in the movie. The term “plot point” shall mean a plot, sub-plot, theme, storyline, principle, idea, key point, clue, and item.

The term “preferences” and the terms “gaming preferences”, shall mean, in the context of a movie trivia game, a user's movie selection preference, a user's preference for one or multiple movie subject categories, a user's audience profile preference, a user's movie release date preference, a user's preferences for the number of participants in a multiplayer session, a user's preference for the level of relative difficulty of the individual trivia questions, and/or such user's preference as may be advantageous or desirable to implement.

The term “pre-established” shall mean that the preference, requirement, condition, variable, factor, or element, whether user or system established, is established at a time prior to, and not at the same time as, the application of the preference, requirement, condition, variable, factor, or element.

The terms “segment” and “movie segment” shall mean one or more video-frames.

The term “supplementary information” shall mean any information, text, data, depiction, images, movie, and/or content, that informs, entertains, elucidates, illuminates, illustrates, clarifies, and/or explains.

The terms “system” and “apparatus” shall mean a system, apparatus, device, mobile device, smartphone, tablet, computing communications device, television, television device, personal computer, laptop, portable computer, remote control device, and any electronic devices capable executing an application.

The term “user” is interchangeable with the terms “player”, “subscriber”, “viewer”, “gamer”, “competitor”, and “person”, and shall mean an end-user person actively using an application, passively, interactively playing a movie game, and/or actively subscribing to and using multimedia, internet, and/or communication services.

The term “write-up” is not necessarily limited to the written word. Specifically, in the context of a movie, a write-up may comprise information, video, and/or a multimedia presentation including video and audio (e.g., a video).

The above defined terms and other terms explicitly defined herein are to be understood as defined in this document, and not as they may be defined by incorporation. Incorporation by reference shall not act to modify, limit, or broaden the definitions hereinabove provided or formally defined in this document. A term that is not formally defined in this document is defined herein to have its ordinary and customary meanings.

In a preferred embodiment, a movie related trivia game application comprises, for example, a system for performing the steps of: downloading movie data; displaying a movie related question responsive to a user's preferences; displaying a plurality of answers associated with the movie related question; and displaying, subsequent to receiving a user's answer selection in response to the displayed plurality of answers associated with the movie related question, supplementary information related to the immediately preceding question. Advantageously, in the movie trivia game, the awarding of points is responsive to a number of tries required by the user to select a correct answer from the displayed plurality of answers associated with a movie related question.

The selection of movie related questions may be responsive to a variety of user preferences including, for example: a user's movie selection preference with respect to a specific movie (e.g., The Matrix), a series of movies (e.g., Star Wars), a genre of movies (e.g., All genres, Action Die Hard, Comedy Ted, Romance Notebook, Science Fiction The Matrix), a specialty classification or subgenre of movies (e.g., Heroes Captain America: The Winter Soldier, Comic Books Sin City, Shoot 'em ups Rambo, Creature Features Godzilla, Apocalyptic Mad Max: Fury Road), a movie's theme (e.g., Honor Beau Geste, Self Actualization Rocky, Relationship Sleepless In Seattle), and/or a movie's conflict (e.g., man vs. man Dirty Harry, man vs. himself The Truman Show, man vs. nature Twister, man vs. society High Noon); a user's preference for one or multiple movie subject categories (e.g., dilemmas, filmmaking, locations, music, plot info, quotes, food recipes, shopping, superfans, trivia, vehicles, weapons, and items identification, and performer/character identification); and/or a user's preference; a user's audience profile preference (e.g., seniors, adults, families, teens, children, couples, gamers, beginners, advanced, movie fanatics); a user's movie release date preference (e.g., Action movies released during the 1980s); and/or a user's preference for the level of relative difficulty of the individual trivia questions (e.g., Easy, Medium, and/or Hard questions), or the difficulty of the assortment of trivia questions (e.g., 3 Easy, 3 Medium, and 4 Hard questions versus 6 Easy, 3 Medium, and 6 Hard questions).

In single player mode, the game comprises displaying a plurality of trivia questions, each of which is associated with a plurality of displayed answers; receiving a user's answer selections in response to each of the displayed plurality of trivia questions; and awarding in-game currency responsive to the points awarded during the game. In multiplayer mode, the points awarded to a user's answer selections in response to the displayed plurality of trivia questions is then compared to the answer selections, by one or a plurality of users, in response to the displayed plurality of the same trivia questions. Advantageously, the multiplayer trivia game enhances the enjoyment of a user testing their movie knowledge and skill in answering questions against other similarly interested users by implementing gaming functions comprising the risking of in-game currency.

The preferred embodiment of the movie trivia game synergistically integrates the single player mode and the multiplayer mode. The novel implementation, within the movie trivia game, of a single player mode that enables a user to earn in-game currency is utilized to fund the user's participation in the multiplayer mode of the movie trivia game. Unlike implementations in other multiplayer games, the single player mode advantageously serves to facilitate the user acquiring the skills, knowledge, and in-game currency to enjoy challenging other users in the multiplayer mode of the movie trivia game. The single player mode also provides a user the opportunity to play the movie trivia game while waiting for a competitor in the multiplayer mode. Further, the multiplayer mode of the movie trivia game motivates a user to play the single player mode, thereby exposing the user to the new movies that are available, to advertisements, and other promotional opportunities.

Generally, a movie trivia game comprises a set of movie related trivia questions and set of answers corresponding to each of the questions. Advantageously the format of the questions and answers varies within the sets and may be presented in written form and/or image/video format. A movie trivia game also provides additional and supplementary information comprising supplementary write-ups and images/videos, supplementary information, information retrieved from a local or remote source, and any other information that a user of the game may deem informative and/or entertaining. While attention is drawn in certain gaming features to some particular exemplary subject category, the information supporting a movie trivia question and related information is not limited to those generally or particularly specified. Advantageously, information items analogous to those specified in one type of category of questions may be utilized in a different category.

The disclosures of U.S. publication 2013/0251337 titled “Providing item information during video playing”; U.S. publication 2013/0343721 titled “Playing A Video Presentation With Playback Functions”; and U.S. publication 2015/0110458 titled “Second Screen Trivia Function are incorporated herein by reference.

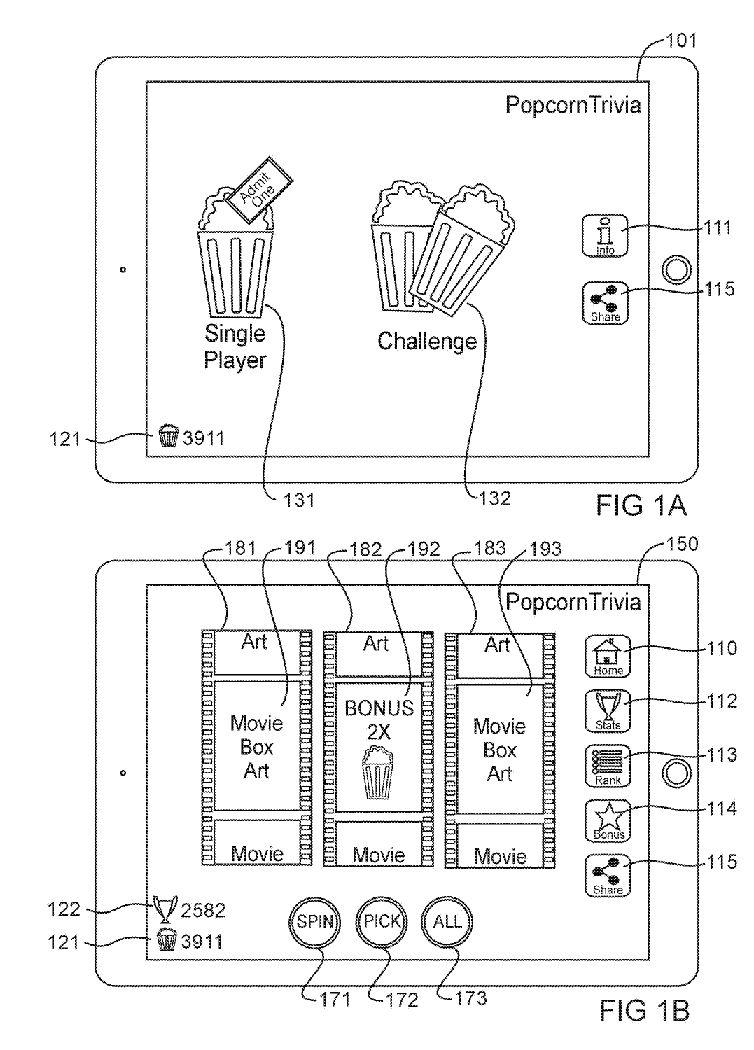

FIG. 1A is an illustration of an application interface enabling the selection of a movie trivia game's single player or multiplayer modes. This particular application interface 101 displays an Info button 111 providing access to the context sensitive info and help features, a Share button 115 providing access to the social media sharing features, and the amount of in-game currency 121 earned by the user (e.g., 3911 Popcorn). The modes interface screen 101 identifies a single player button 131 providing access to the single player mode of the application, and a multiplayer button 132 providing access to the multiplayer mode of the application.

FIG. 1B is an illustration of an application interface enabling the selection of a game session in single player mode. This particular application interface 150 displays a Home button 110 that enables a return to the home screen (e.g., modes interface screen 101), a Stats button 112 that provides access to information relating to the user's scores in each of the movies played, a Rank button 113 that provides access to information relating to the user's rank on a leaderboard among other players (e.g., the Apple Game Center), a Bonus button 114 that access to information relating to the various game bonus and achievement opportunities, and the Share button 115. In addition to the displayed the amount of in-game currency 121 earned by the user, the application interface 150 also displays a cumulative point total 122 that has been earned by the user in single player mode (e.g., 2582).

This particular application interface 150 displays two methods of selecting a single movie to be played and one method of selecting a random set of questions from the total of available movie data sets. A first method enabled by a Spin button 171 comprises the spinning of a slot styled wheels 181 182 183 that randomly present up to three movies that may be selected for play. A second method enabled by a Pick button 172 provides access to a list of movies that a may be specifically chosen without any restrictions. Both methods exclude movies previously completed. A third method enabled by an All button 173 provides the user with a set of questions randomly selected from the plurality of available movies without excluding movies previously completed.

The advantage of the Spin button 171 methodology is that it provides the user with a novel movie selection methodology and an entertaining mini-game within the overall movie trivia game. Such a novel methodology may be applied by, for example, streaming services that deliver the actual movie for playback. For example, a movie box art 191 displayed in one of the wheels 181 may be provided free of charge, when otherwise such a movie would only be available for a fee. Alternatively, or additionally a movie may be included in the wheel that would not be normally available (e.g., pre general release).

In one embodiment, the middle spin wheel 182 is reserved for the random display of the ten most recently released movies, either by the studio released date or the release date of the data set for a movie. The balance of the movies is available in the left spin wheel 181 and right spin wheel 183. In a situation where the movie trivia comprises hundreds of movies, this methodology, of disproportionately allocating movies among the three wheels 181 182 183, advantageously and innovatively increases the probability that a currently released movie/data set is made available to the user.

The Spin button 171 methodology also, advantageously and innovatively, integrates an in-game currency bonus feature that synergistically complements the slot styled wheels 181 182 183. In such an embodiment, the randomization of the display of movie box arts is also subjected to the probability of displaying one, two, or three bonus indicators 192 which impact the in-game currency that is awarded. For example, in a Spin jackpot mini-game embodiment, in which a display of one bonus indicator 192 takes the place of a display of a box art, playing either of the two displayed movies box arts 191 193 results in doubling the in-game currency (e.g., popcorn) that would otherwise have been awarded. If two bonus indicators take the place of a display of two box arts, playing the only displayed movie box art results in multiplying by a factor a five the in-game currency that would otherwise have been awarded. If three bonus indicators take the place of the display of box arts, than the user is automatically awarded a fixed number of units of the in-game currency (e.g., 5,000 popcorn).

In one of many possible embodiments of the Spin jackpot mini-game, the probability that a single bonus indicator is displayed in any one of the three movie box art slots is approximately 1 in 5. The probability that two bonus indicators are displayed in any of the three movie box art slots is approximately 1 in 60. The probability that three bonus indicators are displayed in the three movie box art slots is approximately 1 in 2200. A great many embodiments of the Spin jackpot mini-game altering the display of the bonus, awards, and probabilities are possible. For example, in larger screen devices (e.g., televisions, and tablets) a bonus indicator may be superimposed on a box art enabling only the exclusive play of the superimposed movie box art or the play of each of the three displayed movie box arts.

The advantage of the Pick button 172 methodology is that it provides a user with direct and efficient access to a specific movie that the player has a desire to play the trivia game. The advantage of the All button 173 methodology is that it provides the user a method for experiencing, in single player mode, the multiplayer methodology explained further below.

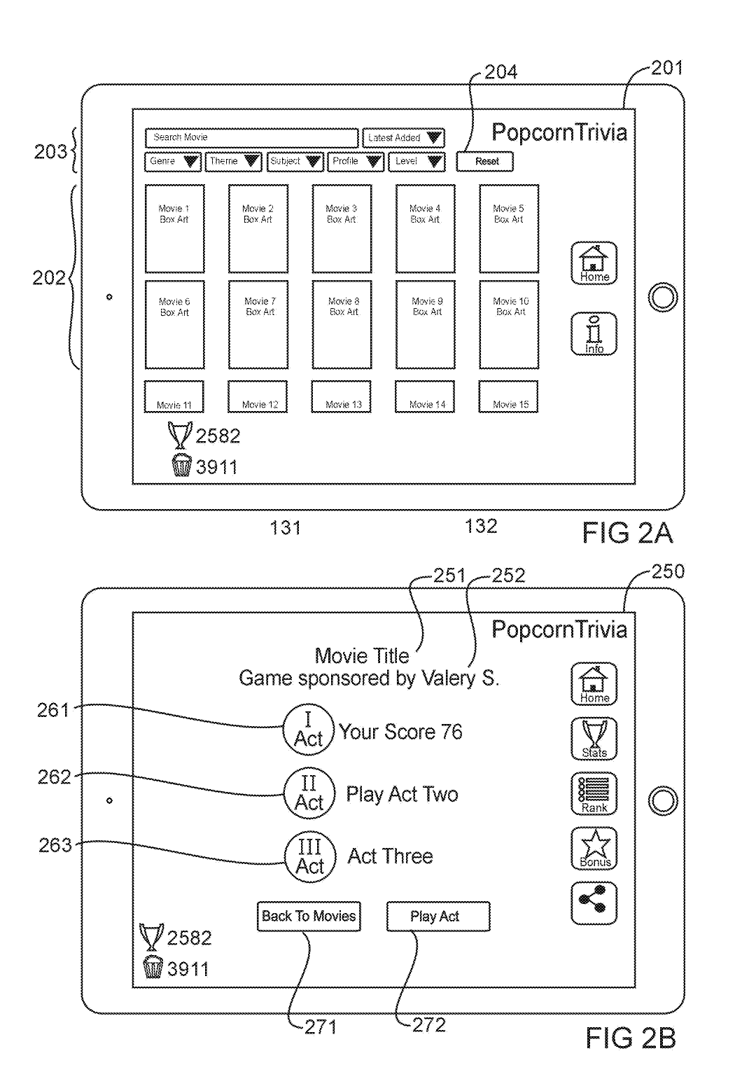

FIG. 2A is an illustration of an application interface enabling the selection of one movie in single player mode. This particular application interface 201 displays the box arts 202 of each of the movies that are available to be played by the specific user. A search bar and drop down menus 203 enable finding and filtering the display of movies by an extensive set of user preferences (e.g., Genre, Theme, Subject, Profile, and Level). A Reset button 204 enables resetting the display of movies to the complete set of movies available to the specific user.

FIG. 2B is an illustration of an application interface enabling the start of an act in a movie selected in single player mode. Advantageously the play of a movie set of trivia questions is divided into 3 Acts of 10 questions each. This enables a user to discontinue playing the movie after each Act and returning at a subsequent time the user is more familiar with the movie. Each Act may be similar in the difficulty of the questions. Alternatively, the first Act may be eschewed towards an easier sample, while the third Act may be eschewed towards a more difficult sample. Because of the potential of collision between questions (e.g., one question revealing the answer for a subsequent question), the order of the questions for all 3 Acts is preestablished.

This application interface enabling the start of an Act in a movie 250 displays the current status of each of the Acts for the selected movie. In a preferred embodiment, the application interface displays the title of the movie 251, and identifies the player 252 (e.g., “Valery S.”) who has sponsored the production of the movie data set by spending the required amount of in-game currency. Illustrated in this example, Act I was previously played 261 and the user achieved a score of 76 points, Act II is next to be played, and Act III 263 may be played after Act II 262. A Back To Movies button 271 allows exiting this particular movie without incurring the penalty associated with discontinuing in a middle of an Act (e.g., the user is credited with the current point achieved and forfeits playing the balance of the Act. A Play Act button 271 enables the routines associated with a playing of an Act.

An object of the movie trivia game in single player mode is to provide a set of questions that are immersed within the context of a single movie and that cover a broad range of entertaining and informative categories. Additionally, a primary, advantageous, and innovative object of the movie trivia game is to introduce to the user the principal features of each of the application's informative and entertaining movie-related subjects (e.g., Dilemmas, Filmmaking, Locations, Music, Plot Info, Quotes, Recipes, Shopping, SuperFans, Trivia, Vehicles, Weapons, and Who) within the context of a challenging game experience. Generally, a feature relates to the format or manner in which information of a subject category is presented or to a particular presentation or methodology associated with a subject category.

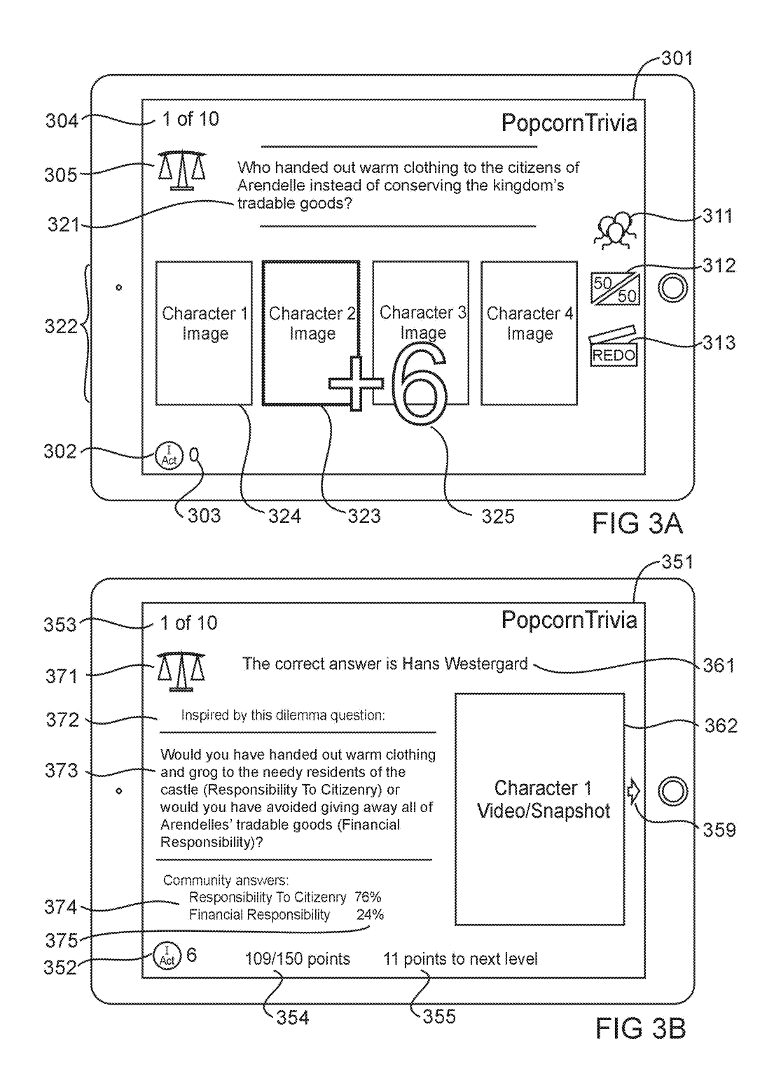

FIG. 3A is an illustration of an application interface displaying information and features of a dilemma question. A moral dilemma usually arises when an individual's decision or action implicates two moral principles that are in conflict with each other, and neither moral principle appears to clearly override the other. Moral principles include, for example, compassion, financial responsibility, obligation to employees, parental responsibility, protection of a loved one, pursuit of soul mate, and self-actualization. In the Spider-Man movie, for example, the character Peter Parker is faced with the decision to either pursue a romantic relationship with Mary-Jane (i.e., Pursuit Of Soul Mate) or sacrifice the potential relationship in order to protect her from his enemies (i.e., Protection Of A Loved One). A moral dilemma is herein referred to as a dilemma, and an agent is the individual facing the dilemma.

The dilemma relationship descriptor is one of a number of possible descriptors that categorizes the social relationship of the agent, e.g., Spouse/Romantic Partner, Parent/Child, Family, Social Relationships, Government, Business/Profession, and Inner Self To facilitate search across a plurality of movies, the relationship descriptors and the moral principle descriptors are advantageously standardized as descriptors of a few words. In the Spider-Man 2 example, the relationship descriptor is “Spouse/Romantic Partner” and the two moral principle descriptors are “Pursuit Of Soul Mate” and “Protection Of A Loved One”.

In the exemplary application interface 301, the Act being played is identified 302 together with a running point total for the Act 303, and the current question and total number of questions are identified 304 (e.g., 1 of 10). Advantageously, the subject category or classification, that is being introduced and that is the source of a question, is identified 305 (e.g., an icon associated with the Dilemma function). Associating the identification of the specific subject category 305 with a question 321 may motivate a user interested in that particular category or classification of questions and information to additionally limit future playback of a movie trivia game in the All mode to a preferred category or classification.

In this example, the movie trivia game question 321 is: “Who handed out warm clothing to the citizens of Arendelle instead of conserving the kingdom's tradable goods?” In this embodiment the user is presented with the images of four characters 322 depicted within the movie. Advantageously, the movie trivia game is standardized as one question 321 and four optional answers 322 irrespective of the feature from which the question is obtained. For example, as depicted in FIG. 3A, in the movie trivia game, the dilemma question 321 is associated with the depiction of the images of four characters 322 from the corresponding movie.

Standardizing the number of question facilitates implementing a multi-try methodology in which a user is provided at least two opportunities (attempts, tries) to identify the correct answer to a question. The multi-try methodology also implements a point scoring system that is responsive to the multiple-try scheme. For example, in a three try embodiment, an identification of a correct answer on a first attempt is associated with 10 points, an identification of a correct answer on a second attempt is associated with 6 points, an identification of a correct answer on a third attempt is associated with 2 point, and a default final answer receives no points. The number of tries that are provided need not be one less than the number of potential answers. For example, a user may be provided two tries to select a correct answer from a potential of four or five displayed answer options.

In the exemplary interface screen 301, an incorrect first attempt is followed by an appropriate incorrect audio sound and the highlighting of the selected answer 323 to both confirm the selection and to remind the user of a previous incorrect selection. A correct selection 324 is followed by an appropriate correct audio sound and a brief display of the awarded points 325 (e.g., +6).

During each act a user is provided the opportunity to use three features intended to assist the user in selecting a correct answer. The Community icon 311 enables the display of percentages of the first answer selected by the community of users. The 50/50 icon 312 enables the elimination of two incorrect answers. The Redo icon 313 withdraws the last incorrect answer. Each of the Community, 50/50, and Redo features may only be used once during an act. Advantageously, the features encourage strategic thinking (e.g., utilizing the 50/50 and Redo features in a single question, and efficiently timing of the use of the features to maximize points.) Optionally, the availability of the Community, 50/50, and Redo features may involve, for example, the expenditure of in-game currency or achieving some other in-game challenge.

A movie trivia may incorporate a variety of different scoring methodologies, and the scoring methodologies need not be same within the same movie or be same from one movie to the next movie. For example, a game may incorporate a classic methodology in which one point is awarded for each correct answer on a first try only. Alternatively, a game may incorporate a timed-countdown methodology in which a clock counts down from 30 seconds beginning 10 seconds after the question is first displayed. Points are awarded based on how quickly the answer is provided, 30 points are awarded if the correct answer is provided within the 1rst second, 29 points if within 2nd second. At 30 seconds a question can no longer be answered and no points may be awarded. Still alternatively or additionally, even in the context of a multi-try methodology, a game scoring may reflect the relative difficulty level of each question.

In a preferred embodiment, consistent with the innovative object of the movie trivia game, the identification of a correct answer by either the user or by default is not immediately followed by a next question. Rather, the identification of a correct answer is followed by additional information highlighting the features of the subject category associated with the recent question. In a preferred embodiment, the interface screen 301 of FIG. 3A displaying information and features of a dilemma question in the movie trivia game is followed by an interface screen displaying information and features of the subject category.

FIG. 3B is an illustration of an application interface displaying information and features of the dilemma subject category. In the exemplary application interface 351, the Act being played is identified together with a running point total for the Act 352, the current question and total number of questions are identified 353 (e.g., 1 of 10), and the. Subject category that is the source of a question is identified 371 (e.g., an icon associated with the Dilemma function). In a preferred interface screen embodiment, an updated running point total or score for all the movies played is displayed 354 (e.g., 109/150 points) together with updated information relating to the number of additional points necessary to achieve an award level 355 (e.g., 11 points to achieve a next level). A next icon 359 enables the user to advance to the next question, if available, or to the completion of the game (e.g., the award screen).

Keeping with a motif of the movie trivia game, a user progresses through movie themed levels by the accumulation of points earned during the game play. In a preferred embodiment, movie themed levels begin with an “Overnight Cleaning Crew Member” level (position) which does not require earning any points. The next level “Studio Security Guard” is achieved with an accumulated point total of 200, which should realized by an average user with the completion of the playing of all three acts in a movie. Example of other levels and points include: “Hard-Working Production Assistant” 1,100, “Lead Camera Operator” 7,100, “Renowned Cinematographer” 27,100, and “Major Hollywood Studio Head” 33,400.

The levels may be fixed to specific point totals as the examples illustrate and/or implement a variable methodology that takes into consideration the continued addition of movies to the game. By contrast to conventional implementations, this methodology results in a user, who has not been actively earning points, to drop to a lower level. For example, in the instance that the total number of available movies is 70, achieving a level of, for example “Hard-Working Production Assistant” requires 1,100, “Daring Stunt Man” requires 1,900 points, achieving a level of “Brilliant Editor” requires 8,100 points, and achieving the highest level, i.e., “Major Hollywood Studio Head” requires 13,400 points. At 150 movies the point totals required by the lower levels remain constant to encourage early participation, while the higher levels require greater point totals to maintain. Thus, for example at 150 movies achieving a level of, for example “Hard-Working Production Assistant” requires 1,100 and “Daring Stunt Man” requires 1,900 points, while achieving a level of “Brilliant Editor” now requires 18,900 points, and achieving the highest level, i.e., “Major Hollywood Studio Head” requires 33,400 points.

The conceptual justification for the novel implementation of flexible levels with the potential for loosing an achieved level is that the skills of a user that is not active at a level (position) are diminished and less current. Thus, in a preferred embodiment, a first player plays at least one of a plurality of single-player movie trivia game sessions, the plurality of single-player movie trivia game sessions being associated with an awarding of points that enable the first player to accomplish a level that is responsive to a failure of the first player to play additional single-player movie trivia game sessions.

The flexible methodology may take into account the total number of movies available to be played and thus the total potential number of points that can be earned by a perfect score, a percentage of the movies that a typical user may have been expected to have seen, and an average score per act/movie. Further, user data may also be utilized to adjust the levels to further distinguish among users and to properly value the higher levels. Ideally, a pyramid relationship is maintained between users and the levels to simulate the competitive opportunities available in the movie industry.

Single player mode provides a user the opportunity to earn points which impact the level that is achieved. Advantageously and innovatively, single player mode provides a user the opportunity to earn in-game currency (e.g., popcorn) to use in the multiplayer game, and importantly the opportunity to gain knowledge and skill that is valuable in the playing of the multiplayer game.

In a preferred embodiment, the points earned during a playing of a movie in single player mode are associated with the awarding of in-game currency. In a simple embodiment, one unit of in-game currency is awarded for each point earned in answering the questions. Other embodiments may implement thresholds such that no units of in-game currency are awarded below a certain point total in an act. Further, in a preferred embodiment, achieving a combined point total for the 3 acts in a movie or achieving combined scores in a series (e.g., Star Wars), or merely playing certain movies, combination of movies (e.g., movies directed by a specified director), or sequence of movies (e.g., play each of an actor's movies in release data sequence) would earn additional units of in-game currency. For example, in a preferred embodiment, achieving a combined point total, for the 3 acts in a movie, greater that 210 points out of the total potential of 300 points would be earn the user an extra 100 units of in-game currency.

Advantageously, the game is designed to award 390 units of in-game currency to the intended user of the movie trivia game who has earnestly played all 3 acts in a movie. To facilitate early use of the multiplayer game, each user is initially awarded 100 units of in-game currency.

An immediate function of the interface screen 351 following the completion of a question is to confirm the correct answer (e.g., the identification of the character's name 361 and displaying the correct image of the character 362). Consistent with the innovative object of the movie trivia game, a principal function of the interface screen 351 following the completion of the question is to identify the subject category, by, for example, a function icon 371 (e.g., Dilemma function icon), and a function relationship 372 to the preceding question (e.g., “Inspired by this dilemma question:”), and to provide additional information of the related subject category. In this illustration, the additional information of the related subject category comprises a source dilemma question 373, source selectable responses 374, and statistics based on how the community responded to the source question 375.

In a preferred embodiment the information supporting a Dilemma's question, information, and entertainment features comprises, for example, a moral dilemma game question that is subject matter related to the moral dilemma depicted within the movie, a set of potential answers, and identification of the correct answer, statistics on how the community of users have answered the dilemma game question, a dilemma title, a dilemma write-up to provide a recap and an explanation of the specific moral dilemma being depicted, a movie-frame identifying a video frame representative of the depicted dilemma, a relationship descriptor, two competing moral principle descriptors, a more detailed identification of the moral principles, a detailed dilemma question that presents the moral dilemma depicted within the movie in the context of the moral principles that are in conflict, statistics on how the community of users have answered the detailed dilemma question, a rating of the quality of the dilemma and/or difficulty of the question, information for retrieving from a remote source an in-depth philosophical analysis, supplementary information, and any other information that a user of the dilemma function may deem informative and/or entertaining.

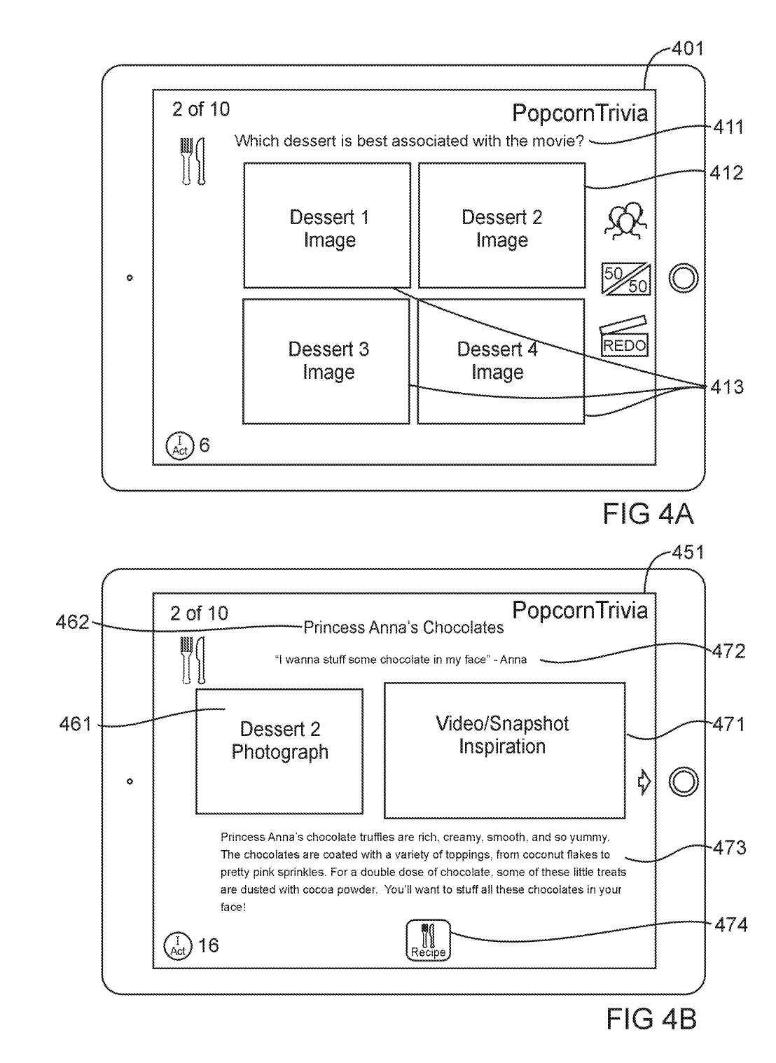

FIG. 4A is an illustration of an application interface displaying information and features of a recipe question. Recipe refers to depictions and/or information relating to a food item such a drink, appetizer, main, side, and dessert. In the exemplary application interface 401, the recipe movie trivia question (e.g., “Which dessert is best associated with the movie?”) 411 is based on the presentation of a photograph of a dessert 412 (e.g., Dessert 2) which has a strong creative relationship and/or is distinctly anchored to the target movie (i.e., the movie on which the question is based). The remaining selectable photographs of desserts 413 (e.g., Dessert 1, 3, and 4) are distinguished from the correct answer 412 by their own creative relationship to, in this example, their respective movies.

The information supporting the recipe subject category may be further supplemented to support other embodiments that are consistent with the movie trivia game architecture. For example, the supplementary information may enable asking the user to select, from a plurality of snapshots selected from within the movie, a snapshot that is the best inspiration for a depicted food recipe. In this and other embodiments, the object is to create a relationship with, and interest in, the underlying subject category.

FIG. 4B is an illustration of an application interface displaying information and features of the recipe subject category. In the exemplary embodiment, the application interface 451, confirms the correct answer 461 (e.g., the correct food item photograph of the dessert is displayed), and provides additional information related to the correct answer 462 (e.g., the identification of the food item “Princess Anna's Chocolates”).

In a preferred embodiment, the additional information features of the recipe subject category provide, for example, a movie video/snapshot 471 that depicts the inspiration for the food item; a quote 472 (e.g., “I wanna stuff some chocolate in my face”—Anna) from the movie that provides inspiration for, or is creatively related to the depicted food item; a food recipe write-up 473 (e.g., “Princess Anna's chocolate truffles are rich, creamy, smooth, and so yummy. The chocolates are coated with a variety of toppings, from coconut flakes to pretty pink sprinkles. For a double dose of chocolate, some of these little treats are dusted with cocoa powder. You'll want to stuff all these chocolates in your face!”) relating to the identified food item; and a recipe icon 474 that provides access to the actual recipe for the targeted food item (e.g., preparation time, servings, list of ingredients, preparation instructions, purchase links to special items or tools, individual and community ratings, and social media features).

The information supporting the presentation of a recipe question within the movie trivia game is suitable to support a stand alone recipe subject category game. To provide a variety in presentation of the question/answers sets and to increase the potential questions that may be available for a motion picture, additional question/answers formats may be implemented. For example, a recipe image is displayed and a user is asked to select a scene written description from a set of scene written descriptions that best inspires the recipe. Similarly, a recipe image is displayed and a user is asked to select a video frame from a set of the movie's video frames that best inspires the recipe.

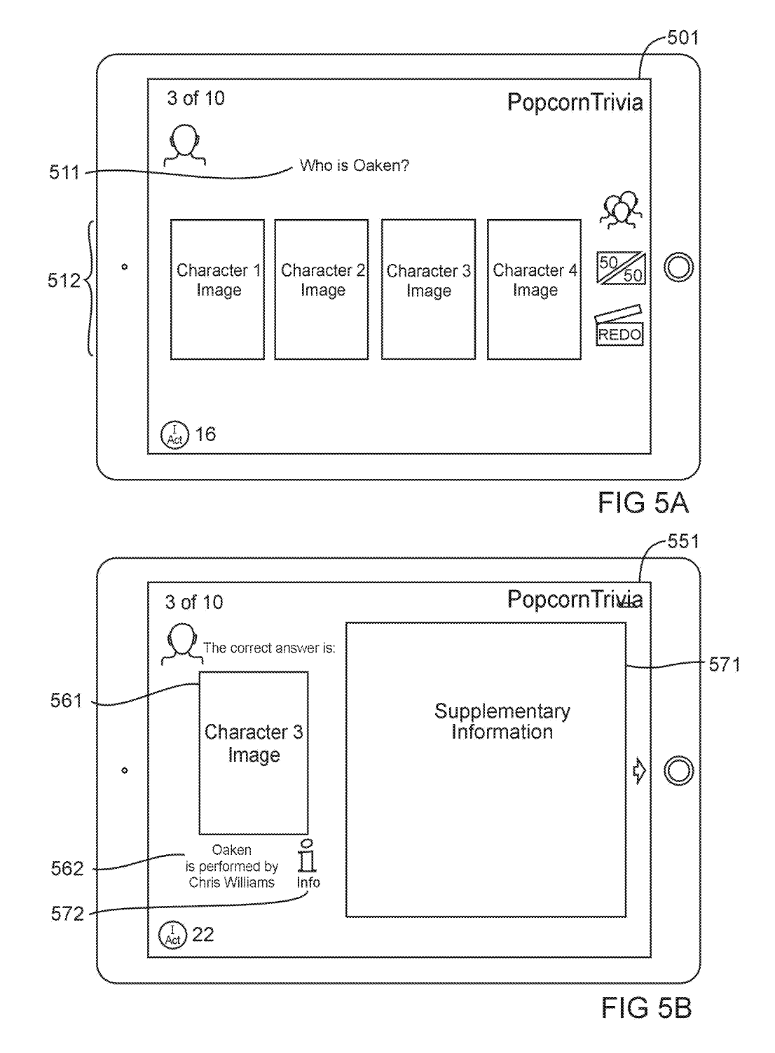

FIG. 5A is an illustration of an application interface displaying information and features of a performer/character identification question. In this exemplary interface screen embodiment 501 of a performer/character identification question, the movie trivia game question 511 is in a written format (e.g., “Who is Oaken?”). In one embodiment, the user is asked to select among the depictions of four character video/snapshots 512 depicted within the movie.

FIG. 5B is an illustration of an application interface displaying information and features of the performer/character category. In the exemplary embodiment, the application interface 551 confirms the correct answer with a snapshot 561 of the correct character (e.g., an image of Oaken), identifies the performer (e.g., Oaken is performed by Chris Williams) 562, and provides supplementary information 571. In this embodiment, responsive to a user preference and linkage information, the supplementary information 571 provided defaults to, for example, a website page providing information about the performer (e.g., Chris Williams IMDb website page) who performed the character (e.g., Oaken in the movie Frozen) and comprises a performer image, biography information, and filmography information. Advantageously, an additional information icon button 572 enables toggling the supplementary information 571 between the performer information and character information. In the case of character supplementary information, the information includes a write-up of the character and additionally or alternatively a linkage to a website page of the character (e.g., disney.wikia.com/wiki/Oaken). In a preferred embodiment, the information icon button 572 enables a user to sequence through a plurality of informative and/or entertaining supplementary information related to the performer and/or the character. For example, in this implementation, the information supporting the category comprises a plurality of website links each specifically chosen for their particularly noteworthy entertainment or information value (e.g., mic.com/articles/79455/7-moments-that-made-frozen-the-most-progressive-disney-movie-ever).

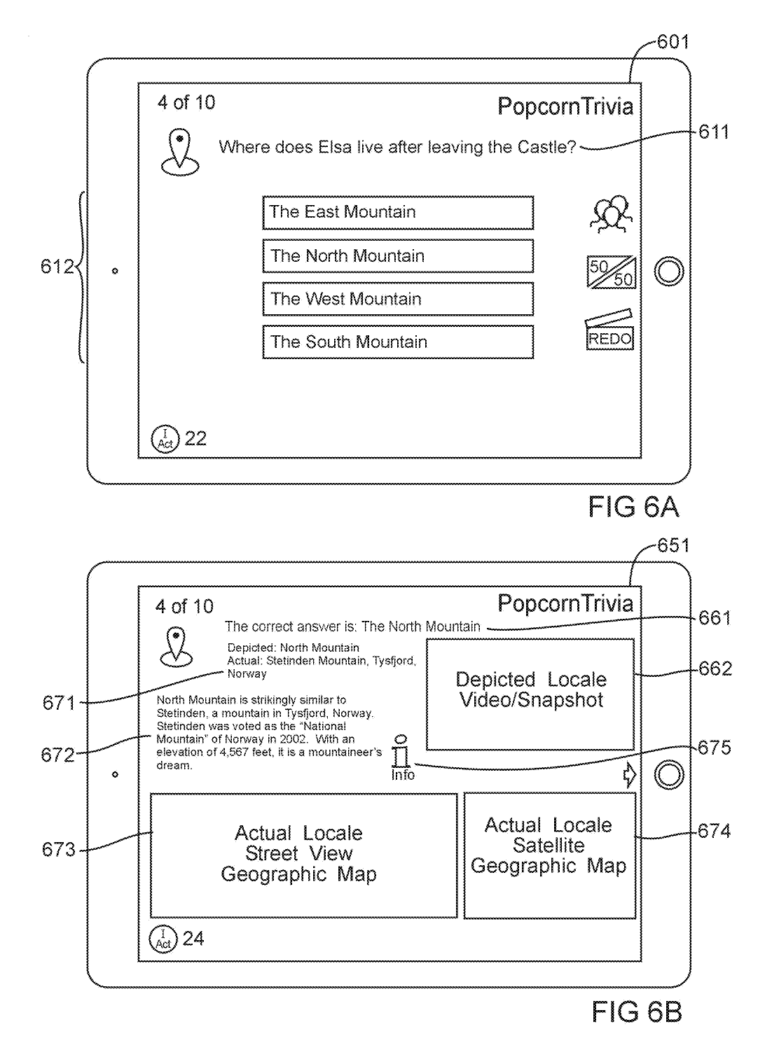

FIG. 6A is an illustration of an application interface displaying information and features of a location question. In a preferred embodiment, the location subject question (e.g., “Where does Elsa live after leaving the Castle?”) 611 is based on the identification of a locale represented or depicted within the movie and included among the four selectable answers 612.

FIG. 6B is an illustration of an application interface displaying information and features of the locations subject category. In the exemplary embodiment, the application interface 651 confirms the correct answer 661 (e.g., “The correct answer is The North Mountain”), and provides a video/snapshot 662 (e.g., a video frame) from within the movie and related to the depicted locale.

Advantageously, in a preferred embodiment, the additional information and features include, for example, an identity of the locale as represented in the movie and an actual identity of the locale 671 (e.g., Depicted: North Mountain. Actual: Stetinden Mountain, Tysfjord, Norway”); a write-up 672 (e.g., “North Mountain is strikingly similar to Stetinden, a mountain in Tysfjord, Norway. Stetinden was voted as the ‘National Mountain’ of Norway in 2002. With an elevation of 4,567 feet, it is a mountaineer's dream.”) related to the identified actual locale (e.g., “Stetinden Mountain, Tysfjord, Norway”); an interactive Street View geographic map of the actual locale 673; an interactive satellite geographic map of the actual local 674 being at substantially the same latitude and longitude as the Street View map but at a substantially different magnification; and an information icon 675 to enable a user to retrieve, for example, corresponding website pages of additional information relating to the actual locale. For example, in the case of a locale being associated with a restaurant, the additional information relating to the actual locale would be a menu of the restaurant's meals.

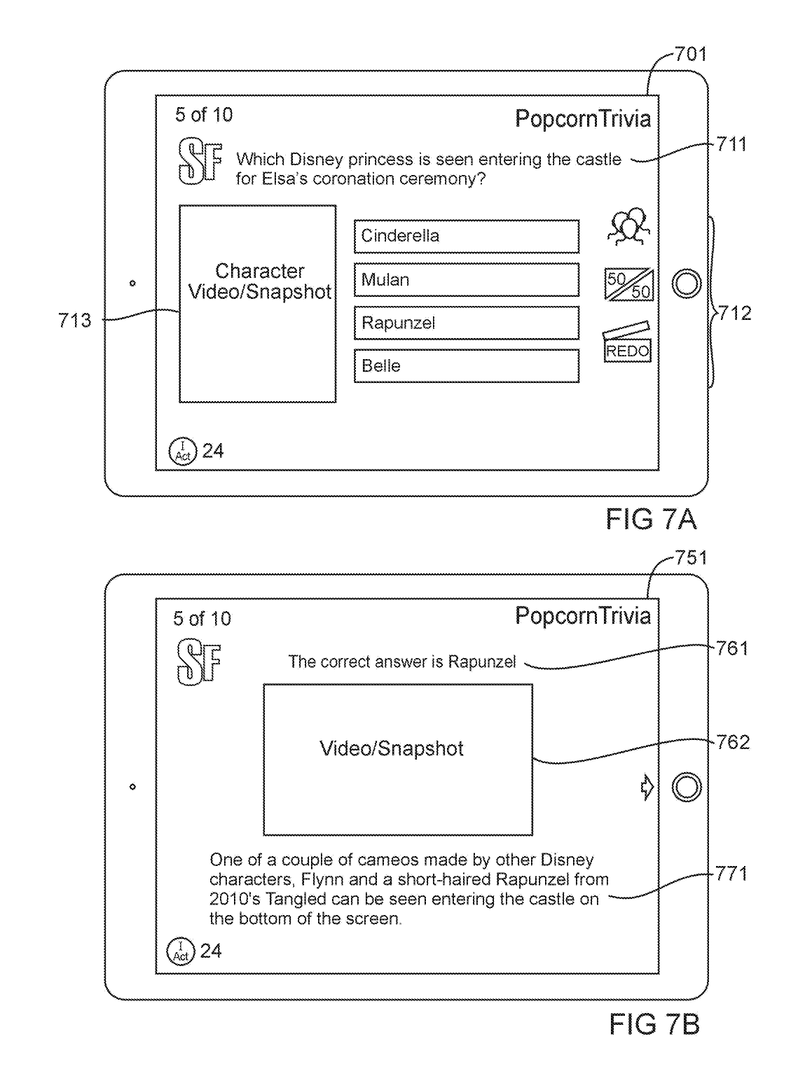

FIG. 7A is an illustration of an application interface displaying information and features of a superfan question. In a preferred embodiment, the superfan subject question 711 (“Which Disney princess is seen entering the castle for Elsa's coronation ceremony?”) is based on the type of information an exceptional fan of the movie might notice (e.g., “One of a couple of cameos made by other Disney characters, Flynn and a short-haired Rapunzel from 2010's Tangled can be seen entering the castle on the bottom of the screen.”). In this exemplary embodiment, the user is asked to select among four written answers 712. In an alternate embodiment, the user may be asked to select among the images of four characters depicted in the respective movies. Optionally, a character video/snapshot 713 may be included in those instances where the question identifies a character (e.g., “Elsa's coronation ceremony”)

FIG. 7B is an illustration of an application interface displaying information and features of the superfan subject category. In the exemplary embodiment, the application interface 751 confirms the correct answer 761 (e.g., “The correct answer is Rapunzel”), provides a video/snapshot 762 (e.g., a video frame) from within the movie and related to the correct answer (e.g., a video frame depicting the Disney character Rapunzel in the bottom of the video frame), and provides additional information such as an information item write-up 771 (e.g., “One of a couple of cameos made by other Disney characters, Flynn and a short-haired Rapunzel from 2010's Tangled can be seen entering the castle on the bottom of the screen.”)

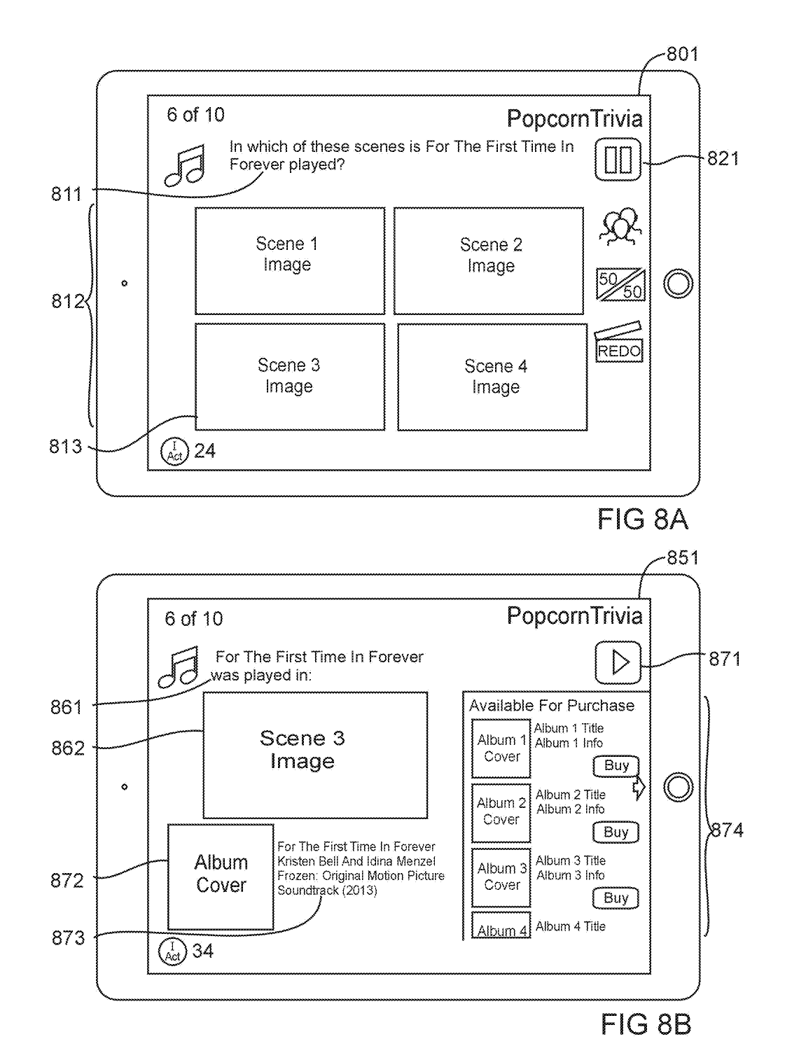

FIG. 8A is an illustration of an application interface displaying information and features of a music question. In a preferred embodiment, the music subject question 811 (“In which of these scenes is For The First Time In Forever played?”) is based on information that identifies the musical item and the location in the movie in which the musical item is played. In this exemplary embodiment, the user is asked to select among the four images 812 (e.g., video frames) of scenes depicted within the movie. One image 813 of the four images corresponds to the correct answer.

In a novel embodiment, the interface screen 801 provides a music Play/Pause icon button 821 which enables a user to pause/play a sample of the musical item. With that object, the information supporting the music category comprises a linkage to a website/server providing an adequate sample of the musical item (e.g., iTunes). Advantageously, responsive to system and/or user preestablished preferences, the playing of the musical item is automatically enabled contemporaneously with an initial display of the question 811. The user, then, as illustrated 821, has the option to pause/stop the playing of the musical item. In those instances when the correct answer to the question is provided by an otherwise playable portion of the musical item, the playing of the musical item is disabled, and the music Play/Pause icon button 821, which generally enables a user to pause/play at least a portion or sample of the musical item, would not be displayed.

FIG. 8B is an illustration of an application interface displaying information and features of the music subject category. In the exemplary embodiment, the application interface 851 confirms the correct answer by, for example, including introductory text 861 (e.g., “For The First Time In Forever was played in:”) and identifying the scene in which the musical item was played 862 (e.g., a video/snapshot of Scene 1). The interface screen 851 also illustrates that the playing of the musical item is in the pause state (i.e., the Play/Pause icon toggle button 871 displays a Play icon).

In a preferred embodiment, additional information includes, for example, an Album Cover illustration/photo 872 of the album that includes the musical item; and information relating to the musical item and/or the album 873 (e.g., musical item title: “For The First Time In Forever”, artists: “Kristen Bell And Idina Menzel”, album title: “Frozen: Original Motion Picture Soundtrack”, and release year: “2013”). The additional information may also include purchase information 874 relating to the musical item featured in the music question. The purchase information may comprise, for example, and identification (e.g., album cover, album title, and information) of the various albums that include the musical item, as well as one or a plurality of purchase icon buttons for each musical album. Purchase information need not be limited to purchase of an album or musical item. Subscription services may also be identified.

An advantageous feature of the movie trivia game is that the variety of the formats that the questions and answers can take enables avoiding repetition of presentation. Additionally, the potential to use any one of a plurality of the illustrated formats and potential permutations provides flexibility as to the types of questions that may be asked and the fact that a number of different questions may be asked that are drawn to the same item. Accordingly, a subject category's question and answer format is not limited to the specific formats illustrated for that subject category. For example, while the format for the music question has been illustrated as four images (e.g., video frames) of scenes depicted within the movie, a music question may instead be formatted as requiring the selection among the depictions of four character video/snapshots depicted within the movie.

The interface screens providing supplementary information or displaying additional information and features would be responsive to the question and answer format implemented. For example, in the case that the answers are images of characters, the introductory text and scene image would be replaced with appropriate introductory text and a correct character image. Further, while the use of video/snapshots is more advantageous in the context of a movie related application, in a simple embodiment the user may be presented with a written question and be asked to select among four written answers. The advantage of being able to implement a variety of formats, within a single movie, is that it provides more flexibility as to the questions that can be asked and the manner in which they may be asked, and provides the user with greater visual diversity.

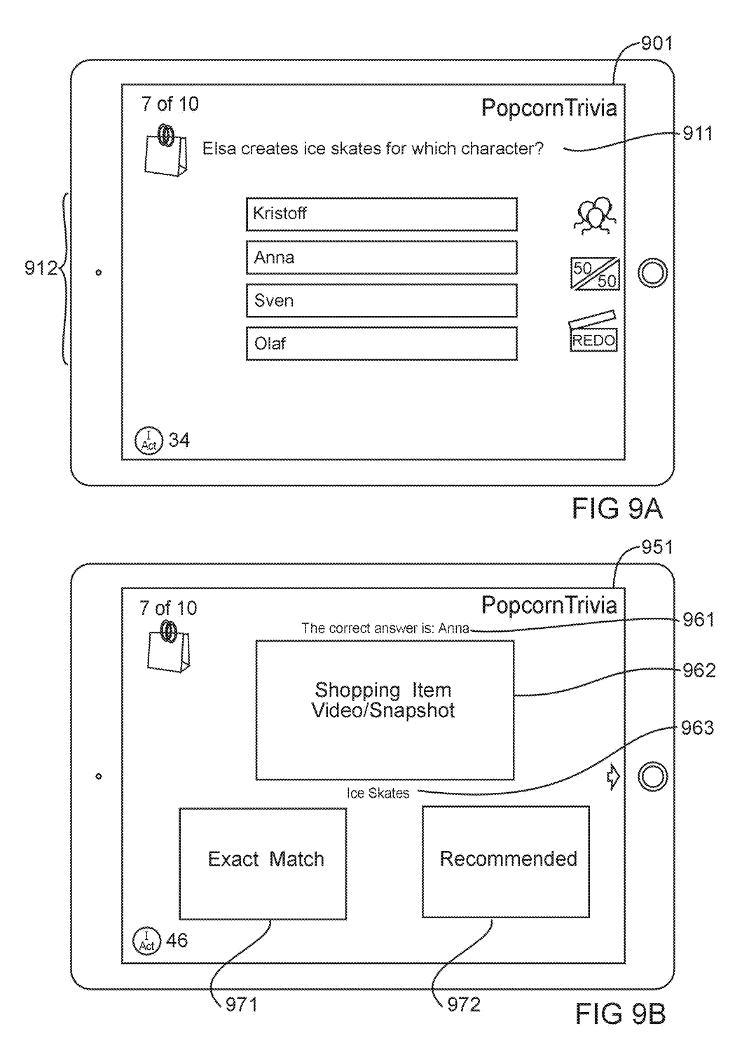

FIG. 9A is an illustration of an application interface displaying information and features of a shopping question. The shopping category refers to depictions and/or information relating to an item depicted within the movie, a locale depicted within the movie, and any depiction within the movie that presents a shopping, advertising, or commercial opportunity. In the exemplary application interface 901, the shopping movie trivia question (e.g., “Elsa creates ice skates for which character?”) 911 brings attention to the noteworthy ice skates depicted within the movie. In the illustrated interface 901, the answer options (e.g., Kristoff, Anna, Sven, and Olaf) are provided in a textual format 912. In a preferred embodiment, and as disclosed above, the answer options 912 may instead have been provided as images of the corresponding characters.

FIG. 9B is an illustration of an application interface displaying information and features of the shopping subject category. In the exemplary embodiment, the application interface 951, confirms the correct answer 961 (e.g., “The correct answer is: Anna”), provides an image within the movie highlighting the item 962, and provides an identification of the featured item 963.

In a preferred embodiment, the additional information features of the shopping category provide, for example, an image/video providing information/access to shopping information available for many options relating to the identified item, for example, an image and label indicating availability of an exact match 971, and an image and label indicating availability of an recommended item 972. In the example, of Anna's ice skates, and exact match 971 is fanciful, while the recommended pair of ice skates 972 may incorporate the latest technology and fashion in a pair of ladies ice skates. Further, the additional information associated with a shopping question that enable retrieving and displaying multiple shopping opportunities, are not limited as to which specific items are displayed. For example, website page of an item (e.g., a ice skates) from one merchant may be simultaneously displayed in combination with multiple complementary items or services (e.g., location of a nearest skating rink). Similarly, the shopping routines are not limited as to the type/format of the information. Combinations of videos, images, website pages, multiple pages from the same website, and/or applications may be utilized. For example, a website page of an item may be combined with an instructional video of the item from youtube.com.

As the exemplary embodiments demonstrate, a feature, structure, method, or step that is disclosed with respect to a certain subject category may be similarly implemented in another category, or in another feature or function that is responsive to one or a plurality of user preferences. For example, a gaming format analogous to one of illustrated with respect to the recipe subject category may be implemented with respect to the Vehicles and Weapons subject categories.

The format of a question is not necessarily limited to a single written or image/based question and a fixed number written or image/based answers. For example, a user may be asked to match each of a plurality of movie box arts (e.g., “Predator”) with a corresponding image of a weapon from a plurality of images of noteworthy or iconic weapons (e.g., “Old Painless”) depicted within the movie. With respect to the Quotes function, for example, a user is provided a set of quotes and a set of video frames from within the movie and is invited to match each of the quotes with a corresponding scene or character. Each of the quotes is selected from a different scene within the movie to avoid potential duplication.

in a preferred embodiment, a system performs the steps of: displaying a movie related question derived from a data set of movie related trivia questions that are each responsive to at least one of a plurality of subject categories and/or a user's preference; providing for multiple tries for a user to select a correct answer from a displayed plurality of answers associated with the movie related question; awarding points responsive to a number of tries required by the user to select a correct answer from the displayed plurality of answers associated with the movie related question; and displaying, subsequent to receiving a user's answer selection in response to the displayed plurality of answers associated with the movie related question, supplementary information.

In such an embodiment, a movie related subject categories may relate to, for example, locales depicted within the movie, identifications of weapons depicted within the movie, moral dilemmas depicted within the movie, and to food recipes inspired by depictions within the movie; the displaying of information from the movie related subject category further comprises displaying a feature of the movie related subject category; the displaying of information from the another movie related subject category further comprises displaying a feature of the another movie related subject category; and/or the displayed plurality of answers consists of a standardized number of answers irrespective of the information of the movie related subject category from which the movie related question is derived.

Upon a user completing the questions of a movie act in the movie trivia game, the user is provided information and statistics that are responsive to how the user answered the questions and the user's progress to date. For example, the score information identifies the points earned during the act, total accumulated points earned, the level achieved (e.g., “Well-Trained Location Scout”), the units of in-game currency earned during the act, and the accumulated units of in-game currency earned to-date. This information is further supplemented by a Stats screen that provides information and statistics on each movie/act played, total movie and total acts played, averages for each completed movie. The information and statistics may be filtered and compiled responsive to any number of the preferences. For example, the user may have an average score of 86 points in Action movies, an average score of 92 points in Heroes movies, and an average score of 89 points in movies released during the 1980s.

At the conclusion of, or prior to, playing an act/movie in single player mode, a user may select to play a multiplayer session of the movie trivia game. A playing of a multiplayer session of the movie trivia game comprises at least two users competing as to who can achieve the best score in answering the questions of the movie trivia game. The disclosure herein provides for a great many embodiments. In the simplest form, two users would be presented with two sets of questions and each of the users would required to answer under a set of rules designed to maximize the user's enjoyment of the movie trivia game. To that extent, while the rules may apply equally to each user, advantageously, the rules may favor one user over the other competing user to take into consideration material differences in demonstrated skill level and knowledge between competing users. For example, a user may be handicapped a number of points based on their average scores.

In the simplest of embodiments each user is presented with a set of questions, and the user scoring the highest number of correct answers is awarded a win to his record. The leader board in such an embodiment would take into account the won-loss record (e.g., absolute wins, win/loss differential, percent of wins, and/or questions answered correctly). In a preferred embodiment, each user that is matched in a multiplayer session is presented with the exact same set of questions (e.g., 10 random questions from within the combined movie data sets, or 30 questions from a specified movie not previously played by the competing users in single player mode) and operate under the same rules (e.g., the use of the Community, 50/50, and Redo features).

Advantageously and innovatively, a preferred embodiment of a multiplayer mode synergistically integrates the availability of in-game currency, a user's competition preferences, and games rules to create an innovative gaming experience that users will find challenging, informative, and enjoyable. In such an embodiment, users would risk an amount of their in-game currency in order to compete against a similarly motivated other user (e.g., willing to risk the same amount of in-game currency). The user with the highest score would then be awarded the in-game currency risked by the competitors in that session. The user may be provided the option to indicate the amount of currency willing to risk and/or to challenge a specific user (e.g., a social media platform friend, or a leader board user with a higher ranking). Further, a user may be provided the option to specify the preference or preferences to guide the inclusion and exclusion of questions available for the multiplayer session (e.g., Science Fiction not Superheroes).

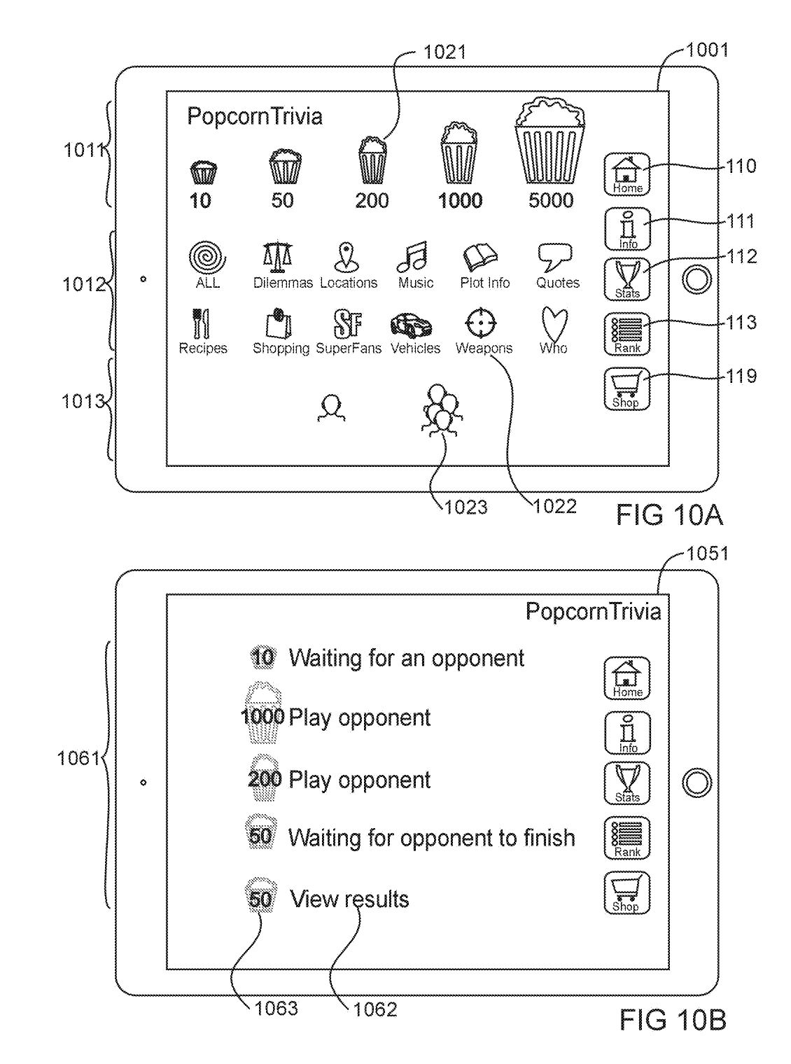

FIG. 10A is an illustration of an application interface enabling the establishment of a movie trivia session in multiplayer mode. This particular application interface 1001 displays a Home button 110 that enables a return to the home screen (e.g., modes interface screen), an Info button 111 providing access to the context sensitive info and help features, a Stats button 112 that provides access to information relating to the user's scores in each of the movies played, a Rank button 113 that provides access to information relating to the user's rank among other players (e.g., the Apple Game Center), and a Shop button 119 that provides access to the application in-game store.

A preferred embodiment of the application interface 1001 enables a user to: (i) select the units of in-game currency the user will risk in a multiplayer session 1011 (e.g., 10, 50, 200, 1000, or 5000 popcorns); (ii) select one or more movie classifications to be played 1012 (e.g., genre, theme, conflict, subject, profile, release date, and difficulty); and specify the number of competitors 1013 (e.g., a single other player, 2, 3, 4, or 5 other players), and/or the type of competitors (e.g., a group of players, or similarly rated users). In the exemplary illustration of FIG. 10A, a user has defined a multiplayer session by selecting the 200 popcorns risk 1021, the Weapons classification 1022, and multiple opponents 1023. Thus, in this illustrative example, the multiplayer movie trivia game session is not only responsive to a game session involving questions that are responsive to the Weapons classification, but the game session is further responsive to a preference of the player to compete simultaneously against multiple other players each risking an equivalent amount of the in-game currency (i.e., 200 popcorns). Thus, in this illustration a total of four players will compete for a total of 800 popcorns.

If no other user has established a matching multiplayer session preferences, then a notification is displayed indicating that the user has initiated a multiplayer challenge (e.g., “Waiting for opponent”). If another user had previously established a matching multiplayer session preferences, or another user subsequently establishes a matching multiplayer session preferences, then a notification is displayed indicating that a competitor has been identified and the multiplayer game session is ready to be played (e.g., “Play Opponent”). Advantageously, a user may be permitted to have any combination of a plurality of multiplayer sessions in progress (e.g., “Waiting for an opponent”, “Play opponent”, “Waiting for opponent to finish”, and “View results”).

FIG. 10B is an illustration of an application interface depicting the display of a user's pending movie trivia sessions in multiplayer mode. In a preferred embodiment, an application interface 1051 identifies each in-progress multiplayer game sessions 1061. The status of the multiplayer session is indicated 1062 as well as the amount of in-game currency that is being risked 1063. A similar interface may provide similar display of completed multiplayer game sessions together with results and competitor information (e.g., games won, average score).

Activating a “Play opponent” notification causes the display of multiplayer game statistics for the user and for the opponent (e.g., units of in-game currency won, multiplayer game sessions played, multiplayer game sessions won, and average points scored in multiplayer game sessions, and the game session is ready to be played by each of the participating users. Once a game session is ready to be played, a set of 10 questions are randomly selected from the set of questions that are responsive to the session preferences (i.e., in this example, the Action classification) and are presented to each of the participants in the session. Each user is notified (e.g., “Play opponent”) that a challenge has been established and has a defined amount of time (e.g., 36 hours) to answer the challenge by beginning to answer the set of questions. Once a user begins answering the set of questions, the user has a predefined amount of time to answer each question (e.g., 30 seconds). There is no time limit imposed to the user during the confirmation of the correct answer and the presentation of additional information and supplementary information. There is also no time limit imposed on the user to complete the set of questions other than complete the set within the total defined amount of time (e.g., 36 hours) to answer the challenge.

Following the user competing answering a multiplayer game session, the user score is displayed. If the game session has also been completed by the opponent or opponents, then the score of the participants are displayed. The user with the highest score would then be awarded the in-game currency risked by the competitors in that session. A multiplayer leader board lists the users in order of the amount of in-game currency won in multiplayer game sessions.

The movie trivia game provides many opportunities for novel methodologies for the acquisition and expenditure of in-game currency. For example, a user may purchase, with in-game currency and/or monetary value, a special movie data set (e.g., “Game Of Thrones”) not otherwise included in the movie data sets available in single player mode.

Additionally, advantageously, and innovatively, a player who for example, achieves the level of, for example, “High-Powered Producer”, may finance the production of a movie data set for a user's favorite movie for which a movie data set has not been previously released. Financing the production of such a movie data set may involve the expenditure of in-game currency and/or monetary value. For example, a user would submit the title of a theatrically released motion picture, and pay the production fee (e.g., 100,000 popcorns). If the motion picture is accepted for production by the application or movie data set provider, it is scheduled for production responsive to the other production requirements (e.g., high priority recently released motion picture). Alternatively or additionally, the user may select a movie to sponsor from a list of pre-approved movies (e.g., cult classics) which may not otherwise be scheduled for production. Such a selection would be automatically approved and scheduled for production. Advantageously, such a sponsor of a movie data set may have his/her name, handle, or identifier displayed with the presentation of that movie data set in single player mode.

Still further, a user may partially sponsor the production of a movie suggested by another user or included in a pre-approved list which may not otherwise be produced or produced in the near term. The later option provides the opportunity for a plurality of users in combination to invest in-game currency necessary to finance the production of a movie data set.

In addition to those opportunities disclosed herein, a person knowledgeable in the art appreciates that there are many other opportunities available for the acquisition and expenditure of in-game currency, whether thematically related to a movie trivia game, as the above examples illustrate, or as is conventionally implemented in other applications that utilize in-game currency. Further, U.S. Pat. No. 8,764,553 titled: “Real-Time Interactive Wagering On Event Outcomes”; U.S. patent publication 20140194209 titled: “Platforms For Community Game Development And Community Management Of Game Lifecycle” are incorporated herein by reference.

The display of questions, answers, additional information, and supplementary information, in a multiplayer movie trivia game session is similar to those illustrated previously with respect to the single player movie trivia game session. The significant differences are that in a multiplayer session, because the set of movies may be from a range of movies, the title of the movie is presented prior to, or contemporaneously with, the display of each question. Additionally, a timer displays the time left that the user has to respond to a question. Advantageously, an audible signal is sent during each of the last five seconds to alert the user. If a user fails to answer the question in the allotted time, the correct answer is displayed.

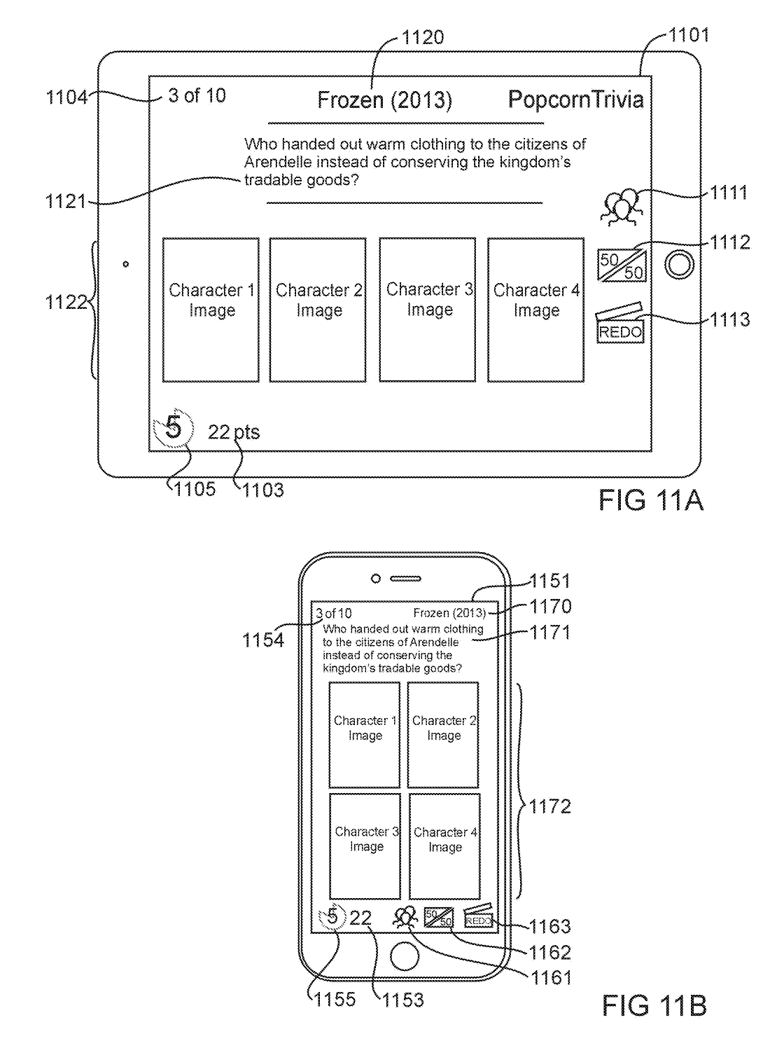

FIG. 11A is an illustration of an application interface displaying information and features of a dilemma question in the movie trivia game during a multiplayer session. Similar to FIG. 3A, the application interface 1101 of FIG. 11A also displays a running point total for the session 1103 (e.g., 22 pts), identifies the current question and total number of questions 1104 (e.g., 3 of 10), displays the question 1121 (e.g., “Who handed out warm clothing to the citizens of Arendelle instead of conserving the kingdom's tradable goods?”, and the four optional answers 1122 (e.g., the images of four characters depicted within the movie). As in the single player session, in a preferred embodiment the multiplayer session also implements the multi-try methodology that incorporates a point scoring system that is responsive to a multiple-try scheme, as well as the implementation of the Community button 1111, 50/50 button 1112, and Redo button 1113 that enable the respective features. FIG. 11A additionally displays the title of the movie and release year 1120 (e.g., “Frozen (2013)”) from which the question 1121 and answers 1122 are derived, and the countdown timer 1105 (e.g., 5 seconds left from the 30 seconds that are allocated).

The advantages of an electronic game implementation are that the movie trivia game may be easily updated to be responsive to the experience of the users. For example, the scoring of a question may be responsive to the countdown timer so that a faster first try correct answer is associated with a higher point total that a slower first try correct answer. Still further, while not obvious, it should appreciated that the continuous release by the movie studios of new movies and the ensuing release of new movie data set provides an opportunity to adjust, for example, the difficulty level of the questions, and the assortment of questions responsive to any of the various user's preferences, balance classifications and add new classifications.

It is noted that while certain exemplary embodiments are detailed with respect to a device in landscape mode, the preferred embodiments are not limited to the exemplary illustrations. While most of the FIGS illustrate the use of a tablet (e.g., an iPad), an alternate preferred embodiment is based on the use of a smartphone (e.g., iPhone).

FIG. 11B is an illustration of an iPhone implementation of the application interface displaying information and features of a movie trivia game question. A comparison with its iPad counterpart illustrated in FIG. 11A demonstrates that the various embodiments can be readily accommodated by adjusting the layout and placement of the features of the function and by taking advantage of vertical scrolling capabilities of, for example, an iPhone.

The application interface 1151 of FIG. 11B, similar to FIG. 11A, also displays a running point total for the session 1153 (e.g., 22 pts), the current question and total number of questions 1154 (e.g., 3 of 10), a countdown timer 1155 (e.g., 5 seconds left from the 30 seconds that are allocated), the title of the movie and release year 1170 (e.g., “Frozen (2013)”), the question 1171 (e.g., “Who handed out warm clothing to the citizens of Arendelle instead of conserving the kingdom's tradable goods?”, the four optional answers 1172 (e.g., the images of four characters depicted within the movie), and the Community button 1161, 50/50 button 1162, and Redo button 1163 that enable the respective features.

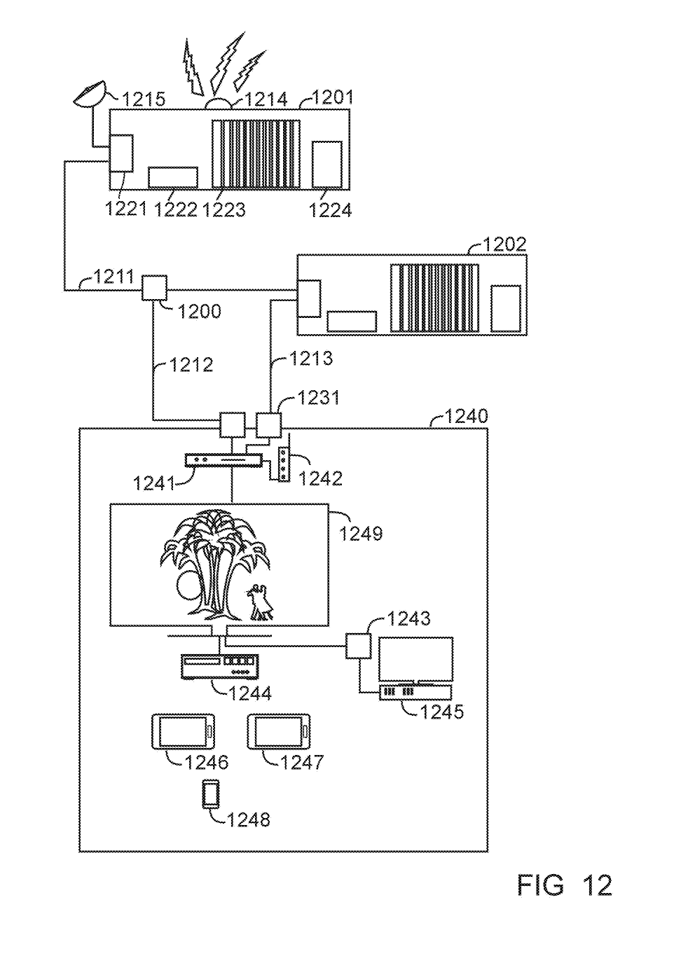

FIG. 12 is a schematic diagram of a communications, systems, apparatus, and devices infrastructure. In a preferred embodiment of the communications, systems, apparatus, and devices infrastructure, providers of a movie data set and supplementary information 1201-1202 are not limited to any information provider or combination of providers. The delivery of movie data sets may be deployable by a variety of possible communications systems, networks, infrastructures, computer and server networks, and system configurations. FIG. 12 suggests a plurality of systems, networks, infrastructures, and system configurations that may be implemented. Shown are wired and non-wired communications networks using, for example, one or a hybrid combination of fiber optic 1211, coaxial cable 1212, twisted copper wire 1213, cellular 1214, and/or satellite 1215.

A movie data set provider, for example 1201, comprises: i) communications technologies for establishing a plurality of data streams to a plurality of end-users 1240 to enable the uploading and/or downloading of movie data and supplementary information; ii) processing hardware and software 1222 for retrieving an end user's movie data preferences, and for processing the user's preferences, and supporting the game features and functions; iii) mass storage random access memory devices 1223 for storing and retrieving data and information supporting the movie trivia game; and iv) processing hardware and software 1224 for maintaining accounting and support services in connection with the various requirements of the movie trivia game.

A user's system access to the resources of a data set and supplementary information provider 1201-1202 need not be direct, and a requested data set may be downloaded, in real time or non-real-time. The downloading of a movie data set need not be completed prior to a playing of a movie act or multiplayer session. Movie data set information, additional information, and/or supplementary information may be downloaded as is particularly needed.

In one of many possible embodiments, an end-user system infrastructure 1240 acquires access to the network 1200 and the various services providers 1201-1202 via a communications system. An end-users system infrastructure 1240 comprises a great variety of systems, communications devices, computing devices, and screens 1241-1249 capable of processing information and instructions executable by a processor and capable of performing the application and features disclosed herein. The end-user's various computing/communicating systems and multi-screen combinations 1244-1249, which include, for example, set top box 1244, e.g., cable box; PC/monitor 1245; tablets 1246-1247; smartphone 1248; and television 1249. An end user system may be generally categorized as principally a communications device, a computing device, or a screen. However, systems, such as tablets 1246-1247, smartphones 1248, and portable/notebook computers 1245, comprise all three functions and are capable of performing the application's methods and steps. Further, a television system 1249 may include computing, storage, and communications capabilities that may otherwise be separately provided in a set-top box or television media accessory 1244. Communications may be established by any of a variety of wired or wireless communications networks including, for example, Wi-Fi and cellular (e.g., 4G LTE) communications networks.

Implementation of the novel features detailed herein are not confined to the communications infrastructure, services providers, and end-user systems detailed with respect to FIG. 12, a great many alternate or complementary systems, devices, components, elements, and services may be utilized.

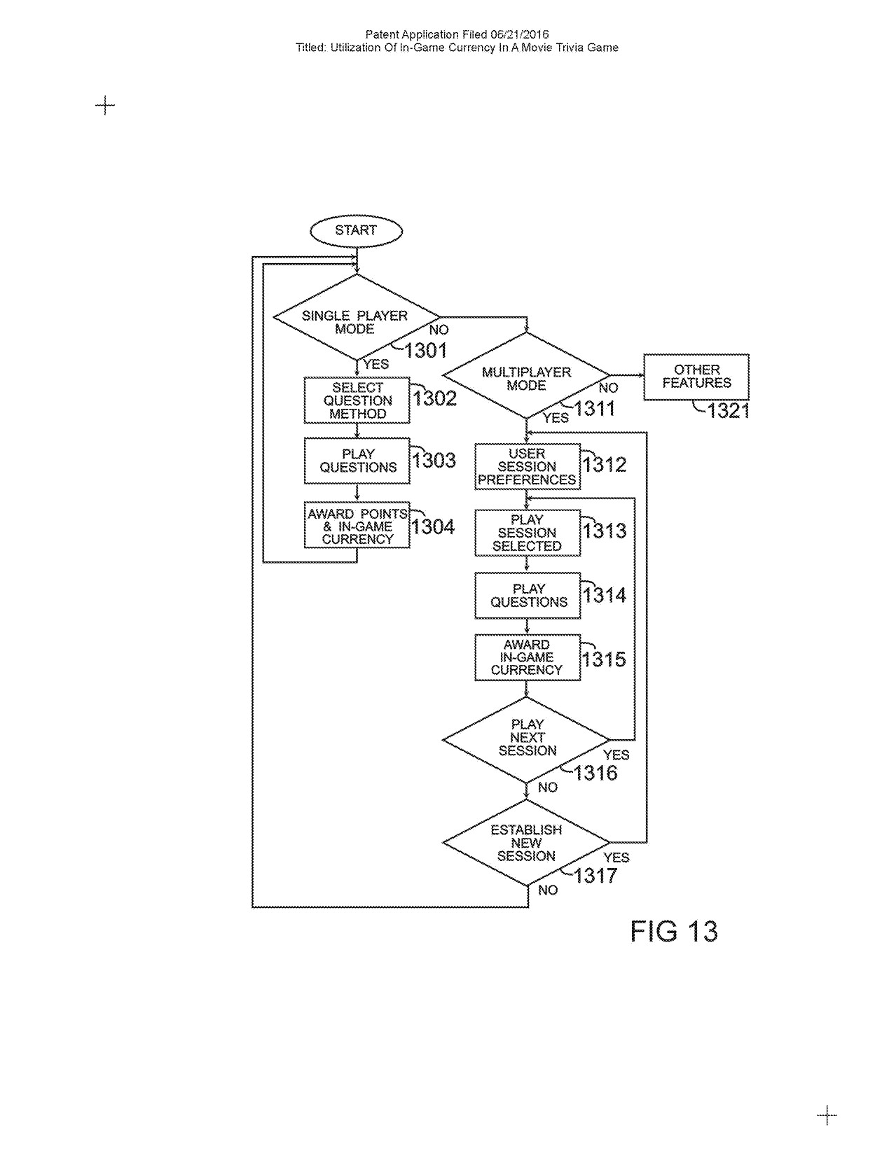

FIG. 13 is a flow chart of a method of playing a movie trivia game. In a preferred embodiment a user would utilize an apparatus, such as a smartphone, tablet, personal computer, system or device capable of processing information and instructions executable by a processor. When a user opens the application, the user is presented with an option as is, for example, detailed with respect to FIG. 1A, to select playing the movie trivia game in single player mode 1301 or in multiplayer mode 1311. If the user elects to play in single player mode 1301, the user may select the methodology used to generate a set of questions 1302 as is, for example, detailed with respect to FIGS. 1B, 2A, and 2B. Once the user has completed playing a session in single player mode 1303 as is for example detailed with respect to FIG. 3A to and including FIG. 9B, points and in-game currency are awarded 1304. At that point, the user may continue to play in single player mode 1301, switch to multiplayer mode 1311, use other features of the application 1321 (e.g., Stats, Shop), or exit the application.

If a user has elected to play in multiplayer mode 1311, then the user establishes one or more movie trivia session preferences 1312 in multiplayer mode as is, for example, detailed with respect to FIG. 10A; selects a session to be played 1313 as is, for example, detailed with respect to FIG. 10B; and plays the session questions 1314 as is, for example, detailed with respect to FIG. 11B. Following completion of a multiplayer game session, in-game currency is awarded 1315 responsive to the results of the competitors of the multiplayer game session. If a user desires to play a next session 1316, a previously established session is selected to be played 1313. Alternatively, if the user elects to establish a new session 1317, the user establishes one or more movie trivia session preferences 1312. If the user does not desire to continue in multiplayer mode 1317, the user may switch to single player mode 1301 or use other features of the application 1321.

In most instances, the awarding of in-game currency 1315 would be responsive to a point differential between the competitors in a multiplayer game session. However, there will be instances where one or more competitors may have the same high point total (e.g., the session is tied). Advantageously, there are a number of desirable methodologies for resolving such session outcomes. In the case of only two competitors in the multiplayer session, the simplest solution is to declare a tie and return the in-game currency to each competitor. Similarly, in the case of multiple competitors, the combined amount of in-game currency is equally divided among the competitors with the tying high scores. Other methodologies may implement a secondary consideration such as rewarding the competitor who answered the questions in the least amount of time; rewarding a competitor with the least use of the Community, 50/50, and Redo features; and/or rewarding a competitor with a lower average score in previous sessions or lesser number of previously played sessions. In a preferred embodiment, a rematch is automatically initiated among the competitors with the tying high scores.

In a preferred embodiment, a method comprises, for example, the steps of: displaying, for a player, at least one of a plurality of single-player movie trivia game sessions, wherein the at least one of the plurality of single-player movie trivia game sessions comprises a set of movie related questions derived from a single movie that is responsive to a movie preference of the player, and wherein the at least one of the plurality of single-player movie trivia game sessions implements a point scoring system that is responsive to a multiple-try scheme; awarding, responsive to the player playing at least one of a plurality of single-player movie trivia game sessions, an amount of in-game currency to the player; enabling the player to establish a multiplayer movie trivia game session by risking an amount of in-game currency awarded to the player in the playing of the at least one of the plurality of single-player movie trivia game sessions; enabling a multiplayer movie trivia game session between the player and another player risking an equivalent amount of the in-game currency, wherein the multiplayer movie trivia game session implements a point scoring system that is responsive to a multiple-try scheme; displaying, for the player and for the another player, a set of questions from a plurality of movie related questions; and awarding, responsive to the multiplayer movie trivia game session, the amount of in-game currency risked by the player and by the another player.

Further, in such an exemplary embodiment, the at least one of a plurality of single-player movie trivia game sessions may be associated with an awarding of points that enable the player to accomplish a level that is responsive to a failure of the player to play additional single-player movie trivia game sessions; the awarding of in-game currency may enable a player to finance the production of a set of movie related questions that are responsive to a movie preference of the player; the movie preference of the player may be established by the player playing a mini-game comprising a spinning of a slot styled wheels randomly displaying movie box arts and comprising an in-game currency bonus feature; and the multiplayer movie trivia game session may be further responsive to a preference of the player with respect to a shoot 'em ups classification of movies.

It is noted that while certain exemplary embodiments are detailed, directly or by incorporation, the inventions are not limited to the exemplary information or features utilized in any mode, feature, function, and/or specific embodiment. An advantage of a particular embodiment, mode, feature, function, information, or element is not necessarily limited to that particular embodiment, mode, feature, function, information, or element. Many variations of the elements included in a particular embodiment are possible by way of permutation, combination, substitution, deletion, and/or additions. A feature or function may be enhanced by the addition of features and information elements (e.g., segment definitions, frame identification, play position identification, image and thumbnail identifiers, write-ups, and linkages) detailed with respect to another function.

The information supporting functions or features of a function is not limited to the information explicitly disclosed herein. The information supporting a specific function or specific feature of a function also comprises the information that is implicit, that is logically necessary to support the feature, and/or that is analogous to disclosed information supporting a different function or a different feature of a function.

The teachings disclosed herein, directly and indirectly by, for example, incorporation, are intended to show a variety of architectures, services, capabilities, systems, methods, and inventive elements which are combined and may be combined to suit particular embodiments. While an object of incorporation is to provide additional detail explanation, the synergies among and between the various inventive elements is a significant feature of and object of incorporation. The incorporation by reference at a specific place within the specification is not intended to limit the extent to which the reference is incorporated, or the manner in which it may be integrated. Where a teaching may be deemed to be at cross purposes, or otherwise incompatible, with some other teaching, it ought to be understood as a possible alternative to be utilized as a particular preferred embodiment may require.

While elements of the inventions have been detailed in conjunction with specific embodiments thereof, it is evident that many alternatives, modifications and variations are possible and will be apparent to those skilled in the art in light of the foregoing descriptions. Accordingly, it is intended to embrace all such alternatives, modifications, variations, and combinations as fall within the spirit and broad scope of the specification. The teachings that have been cited and incorporated herein are offered by way of example, and not limitation, of the underlying foundation of knowledge and skill that is available to a person of ordinary skill in the art. Many of the features, components, and methods found in the art may be incorporated, as suggested herein, in a preferred embodiment; and since other modifications and changes varied to fit particular requirements and environments will be apparent to those skilled in the art, the inventions are not limited to the embodiments set forth or suggested herein. It is to be understood that the inventions are not limited thereby. It is also to be understood that the specific details shown are merely illustrative, and that the inventions may be carried out in other ways without departing from the broad spirit and scope of the specification.

What is claimed is:

1. A method comprising the steps of:
displaying, for a player, at least one of a plurality of single-player movie trivia game sessions, wherein at least one of a plurality of single-player movie trivia game sessions comprises a set of movie related questions derived from a single movie that is responsive to a movie preference of the player;
awarding, responsive to the player playing at least one of a plurality of single-player movie trivia game sessions, an amount of in-game currency to the player;
enabling the player to establish a multiplayer movie trivia game session by risking an amount of in-game currency awarded to the player in the playing of the at least one of the plurality of single-player movie trivia game sessions;
enabling a multiplayer movie trivia game session between the player and another player risking an equivalent amount of the in-game currency;
displaying, for the player and for the another player, a set of questions from a plurality of movie related questions; and
awarding, responsive to the multiplayer movie trivia game session, the amount of in-game currency risked by the player and by the another player.

2. The method of claim 1 wherein the movie preference of the player is established by the player playing a mini-game comprising an in-game currency bonus feature.

3. The method of claim 1 wherein the movie preference of the player is established by the player playing a mini-game comprising a spinning of a slot styled wheels randomly displaying movie box arts.

4. The method of claim 1 wherein the multiplayer movie trivia game session is further responsive to a preference of the player with respect to a comic book classification of movies.

5. The method of claim 1 wherein the multiplayer movie trivia game session is further responsive to a preference of the player with respect to a shoot 'em ups classification of movies.

6. The method of claim 1 wherein the multiplayer movie trivia game session is further responsive to a preference of the player to compete simultaneously against multiple other players each risking an equivalent amount of the in-game currency, and wherein the another player is one of the multiple other players.

7. The method of claim 1 wherein the at least one of a plurality of single-player movie trivia game sessions is associated with an awarding of points that enable the player to accomplish a level that is responsive to a failure of the player to play additional single-player movie trivia game sessions.

8. The method of claim 1, wherein the steps are performed by a player's device in combination with a remote web server that processes API requests from the player's device.

9. The method of claim 1, wherein the awarding of in-game currency enables a player to finance the production of a set of movie related questions that are responsive to a movie preference of the player.

10. A method comprising the steps of:
displaying, for a player, at least one of a plurality of single-player movie trivia game sessions, wherein at least one of a plurality of single-player movie trivia game sessions comprises a set of movie related questions derived from a single movie that is responsive to a movie preference of the player;
awarding, responsive to the player playing at least one of a plurality of single-player movie trivia game sessions, an amount of in-game currency to the player;
enabling the player to establish a multiplayer movie trivia game session by risking an amount of in-game currency awarded to the player in the playing of the at least one of the plurality of single-player movie trivia game sessions;
enabling a multiplayer movie trivia game session between the player and multiple other players, each risking an equivalent amount of the in-game currency;
displaying, for a player and for the multiple other players, a set of questions from a plurality of movie related questions; and
awarding, responsive to the multiplayer movie trivia game session, the amount of in-game currency risked by the player and by the multiple other players.

11. The method of claim 10 wherein the movie preference of the player is established by the player playing a mini-game comprising an in-game currency bonus feature.

12. The method of claim 10 wherein the movie preference of the player is established by the player playing a mini-game comprising a spinning of a slot styled wheels randomly displaying movie box arts.

13. The method of claim 10 wherein the multiplayer movie trivia game session is further responsive to a preference of the player with respect to a shoot 'em ups classification of movies.

14. The method of claim 10 wherein the multiplayer movie trivia game session implements a point scoring system that is responsive to a multiple-try scheme.

15. The method of claim 10 wherein the at least one of a plurality of single-player movie trivia game sessions is associated with an awarding of points that enable the player to accomplish a level that is responsive to a failure of the player to play additional single-player movie trivia game sessions.

16. The method of claim 10, wherein the steps are performed by a player's device in combination with a remote web server that processes API requests from the player's device.

17. The method of claim 10, wherein the awarding of in-game currency enables a player to finance the production of a set of movie related questions that are responsive to a movie preference of the player.

18. A method comprising the steps of:
displaying, for a player, at least one of a plurality of single-player movie trivia game sessions, wherein the at least one of the plurality of single-player movie trivia game sessions comprises a set of movie related questions derived from a single movie that is responsive to a movie preference of the player, and wherein the at least one of the plurality of single-player movie trivia game sessions implements a point scoring system that is responsive to a multiple-try scheme;
awarding, responsive to the player playing at least one of a plurality of single-player movie trivia game sessions, an amount of in-game currency to the player;
enabling the player to establish a multiplayer movie trivia game session by risking an amount of in-game currency awarded to the player in the playing of the at least one of the plurality of single-player movie trivia game sessions;
enabling a multiplayer movie trivia game session between the player and another player risking an equivalent amount of the in-game currency, wherein the multiplayer movie trivia game session implements a point scoring system that is responsive to a multiple-try scheme;
displaying, for the player and for the another player, a set of questions from a plurality of movie related questions; and
awarding, responsive to the multiplayer movie trivia game session, the amount of in-game currency risked by the player and by the another player.

19. The method of claim 18 wherein the at least one of a plurality of single-player movie trivia game sessions is associated with an awarding of points that enable the player to accomplish a level that is responsive to a failure of the player to play additional single-player movie trivia game sessions.

20. The method of claim 18, wherein the awarding of in-game currency enables a player to finance the production of a set of movie related questions that are responsive to a movie preference of the player.
